(19) United States
(12) Patent Application Publication
(10) Pub. No.: US 2019/0002617 A1
(43) Pub. Date: Jan. 3, 2019

(54) RADICALLY CURABLE COMPOSITION AND CURED PRODUCT THEREOF

(71) Applicant: KANEKA CORPORATION, Osaka (JP)

(72) Inventor: Jun Kotani, Osaka (JP)

(73) Assignee: KANEKA CORPORATION, Osaka (JP)

(21) Appl. No.: 16/125,422

(22) Filed: Sep. 7, 2018

Related U.S. Application Data
(63) Continuation of application No. PCT/JP2017/007693, filed on Feb. 28, 2017.

(30) Foreign Application Priority Data
Mar. 9, 2016 (JP) 2016-046087

(51) Int. Cl. C08F 290/12; C09J 7/38; C09J 4/06; F16F 1/36; F16F 7/12

(52) U.S. Cl. CPC C08F 290/126; C09J 7/385; C09J 4/06; F16F 1/3605; F16F 2224/0233; C08F 2810/20; C09J 2451/00; F16F 2224/0241; F16F 7/12

(57) ABSTRACT

A radically curable composition includes 100 parts by weight of a (meth)acrylic polymer (I) with an average of at least 0.8 radically-crosslinkable groups, 0.01 to 10 parts by weight of a radical polymerization initiator (II), and 10 to 100 parts by weight of a (meth)acrylate compound (III) having a rosin ester group.

### TECHNICAL FIELD

One or more embodiments of the present invention relate to a radically curable composition and a cured product thereof. More specifically, one or more embodiments of the present invention relate to a radically curable composition containing a (meth)acrylic polymer having a radically crosslinkable group, and to a cured product thereof.

### BACKGROUND

Rubber materials are used in various fields such as buildings, automobiles, electric and electronic appliance, machinery, logistics, chemicals, medicine/nursing, sports, etc., as adhesives, sealing materials, sealants, pressure-sensitive adhesives, paints, coating materials, resist materials, impact absorbing materials, vibration damping materials, pressure dispersing materials, molded parts, molding materials, and the like.

Among the rubber materials, from the viewpoint of superiority in flexibility vibration-proofing property, impact absorbing property, heat resistance, oil resistance, moisture permeation resistance, and mechanical strength, as well as from the viewpoint of not containing silicone compounds, rubber materials containing a (meth)acrylic polymer as a main component have recently been preferably used. In a curing mode of a rubber material, demand for rubber materials using radical reactions such as photo-radical curing and thermal radical curing is particularly high because of rapid curing and easy handling.

The inventor of one or more embodiments of the present invention has reported that (meth)acrylic polymers that have a (meth)acryloyl group at the terminal and that are obtained by living radical polymerization of the main chain and compositions including the same are suitable for these radically curable rubber materials (Patent Literatures 1 and 2).

The requirements for improving physical properties of these radically curable compositions have been increasing year by year, and there is a strong demand for a technique for controlling viscoelasticity, in particular, to increase the vibration damping properties and impact absorption capability of the obtained cured product. In Patent Literature 3, a technique for controlling viscoelasticity by blending branched polymers is disclosed, but due to the selection of a combination of polymers, the viscosity of the curable composition becomes high and workability is poor. The viscoelastic properties of the obtained cured product can also be controlled at room temperature or lower, such as from −20° C. to 20° C., but it is difficult to control the viscoelastic properties in a wide temperature range equal to or higher than room temperature. Patent Literature 4 discloses a technique of controlling viscoelasticity by blending a polymer having a crosslinkable functional group at one terminal and a polymer having a crosslinkable functional group at both terminals to be co-crosslinked. According to such a method, however the viscosity of the curable composition becomes high, so that sufficient workability cannot be obtained, or it is known that tan δ peak is very large due to the utilization of the energy attenuation in the glass-rubber transition of the polymer, and the tan δ greatly changes in the constant temperature range. In other words, since the polymer has a high tan δ in a certain temperature range, the polymer is used as a good viscoelastic body in that temperature range, but since the change to temperature and frequency is very large, vibration damping properties and impact absorbing properties greatly change when the polymer is out of that temperature range, and as a result it is difficult to design the polymer as a vibration damping material or impact absorbing material. As a result, Patent Literature 5 proposes a viscoelastic body having a small change to temperature and frequency using a polymer having a specific molecular weight with a crosslinkable functional group at one terminal. However when such a high molecular weight substance is used, the viscosity of the curable composition is high, and the workability is poor. Further, although it is possible to control the viscoelastic properties of the obtained cured product at room temperature or lower, such as from −20° C. to 20° C., it is difficult to control the viscoelastic properties in a wide temperature range equal to or higher than room temperature.

In addition, a technique for controlling various physical properties of a rubber material obtained by adding various monomers having (meth)acryloyl groups to these (meth)acrylic polymers having a (meth)acryloyl group has been disclosed (Patent Literatures 6, 7, and 8), but it is difficult to obtain a rubber material that can have a high tan δ value in a wide temperature range in any of such methods.

On the other hand, as a technique for controlling viscoelasticity of a rubbery material, a method of adding a tackifying resin such as terpene resin, rosin resin or the like is known (Patent Literatures 9 and 10). However, in general, the tackifying resin is solid, and in order to disperse the resin in the curable composition, it is necessary, to dissolve the resin in a solvent once to be dispersed, then to remove the solvent, or to melt the resin by raising a temperature. In the case of using a solvent, the solvent volatilizes in the working environment, so that the work environment is deteriorated and there is a risk of explosion. In addition, an apparatus for removing the solvent is necessary, which may be economically burdensome, particularly considering the required consumption of a large amount of energy. Even in the case of melting the resin at a high temperature, there are many economic considerations that must be accounted for, such as a large amount of consumed energy and a large-scale apparatus required for kneading, and in addition, it may be difficult to obtain a rubber material having a high tan δ value over a wide temperature range.

Thus, according to the conventional method, a technique for controlling viscoelasticity of a cured product obtained from a radically curable composition containing a (meth)acrylic polymer having a radically crosslinkable group cannot be obtained with sufficient satisfaction.

### CITATION LIST

### Patent Literature

PTL 1: JP-A-2000-72816

PTL 2: JP-A-2000-95826

PTL 3: WO 2012/043426

PTL 4: WO 2007/069600

PTL 5: JP-A-2011-236364

PTL 6: JP-A-2015-071719

PTL 7: WO 2009/148182

PTL 8: JP-A-2010-126680

PTL 9: JP-A-2012-122022

PTL 10: JP-A-2014-19737

### SUMMARY

One or more embodiments of the present invention relate to a curable composition of a (meth)acrylic polymer having a radically crosslinking group, which is easily kneadable during production and provides a resulting cured product with excellent dynamic viscoelastic properties.

Generally, it is known that a tan δ value in the dynamic viscoelasticity properties is an index representing vibration damping properties, and a larger value shows better vibration damping properties. However, even if only the peak value of tan δ is high, satisfactory vibration damping properties are exhibited at a limited temperature and frequency, and it cannot be said to be practical. In practical use, it is necessary to indicate the tan δ value that is high in a wide temperature range or a wide frequency range, and it is necessary in design that the change in the tan δ value is small.

When a general (meth)acrylate compound is added, a high tan δ value in a sufficiently wide temperature range cannot be obtained, and general tackifying resins are deficient regarding kneadability and are insufficient to exhibit a high tan δ value in a wider temperature range.

In view of the above circumstances, the present inventor has conducted intensive studies on a radically curable composition, and as a result, it has been found that when 0.01 to 10 parts by weight of a radical polymerization initiator (II) and 10 to 100 parts by weight of a (meth)acrylate compound (III) having a rosin ester group are used based on 100 parts by weight of a (meth)acrylic polymer (I) with an average of at least 0.8 radically-crosslinkable groups, kneading and dispersing during production are easily performed, the obtained cured product are excellent in dynamic viscoelastic properties, and a tan δ as high as 0.5 or more is achieved in a wide temperature range equal to or higher than 80° C., extending from a low temperature of −20° C. or lower to a high temperature of 45° C. or higher. This finding has led to the completion of one or more embodiments of the present invention.

That is, one or more embodiments of the present invention relate to a radically curable composition containing 100 parts by weight of a (meth)acrylic polymer (I) with an average of at least 0.8 radically-crosslinkable groups, 0.01 to 10 parts by weight of a radical polymerization initiator (I), and 10 to 100 parts by weight of a (meth)acrylate compound (III) having a rosin ester group.

A preferred embodiment relates to a radically curable composition, in which the (meth)acrylic polymer (I) with an average of at least 0.8 radically-crosslinkable groups is a (meth)acrylic polymer having a radically crosslinkable carbon-carbon double bond at a molecular terminal.

A preferred embodiment relates to a radically curable composition, in which the (meth)acrylic polymer (I) with an average of at least 0.8 radically-crosslinkable groups is a (meth)acrylic polymer having a (meth)acryloyl group at a molecular terminal.

A preferred embodiment relates to a radically curable composition, in which the (meth)acrylic polymer (I) with an average of at least 0.8 radically-crosslinkable groups has a molecular weight distribution of less than 1.8.

A preferred embodiment relates to a radically curable composition, in which the (meth)acrylic polymer (I) with an average of at least 0.8 radically-crosslinkable groups is obtained by polymerization or copolymerization of an acrylic acid alkyl ester monomer containing a saturated hydrocarbon group having 4 to 22 carbon atoms.

A preferred embodiment relates to a radically curable composition, in which the radical polymerization initiator (II) is a radical photoinitiator.

A preferred embodiment relates to a radically curable composition, in which the (meth)acylate compound (II) having a rosin ester group is 1-acrylic acid-3-dehydroabietic acid-2-hydroxypropyl.

Further, one or more embodiments of the present invention relate to a cured product obtained from the radically curable composition that contains 100 parts by weight of a (meth)acrylic polymer (I) with an average of at least 0.8 radically-crosslinkable groups, 0.01 to 10 parts by weight of a radical polymerization initiator (II), and 10 to 100 parts by weight of a (meth)acrylate compound (III) having a rosin ester group.

Furthermore, one or more embodiments of the present invention also relate to a vibration damping material, a pressure-sensitive adhesive, or an impact absorbing material composed of the cured product.

The radically curable composition of one or more embodiments of the present invention is easily kneaded during production, and the obtained cured product can exhibit a high tan δ value over a wide temperature range.

### DETAILED DESCRIPTION OF THE EMBODIMENTS

Components contained in the radically curable composition of one or more embodiments of the present invention will be described below.

<(Meth)Acrylic Polymer (I) with Average of at Least 0.8 Radically-Crosslinkable Groups>

<Main Chain of (Meth)Acrylic Polymer (I) with Average of at Least 0.8 Radically-Crosslinkable Groups>

A molecular chain (main chain) of the (meth)acrylic polymer (I) with an average of at least 0.8 radically-crosslinkable groups of one or more embodiments of the present invention is composed of a homopolymer or copolymer of one or more (meth)acrylic monomers, or a copolymer of one or more (meth)acrylic monomers and a vinyl-based monomer copolymerizable therewith. The (meth)acrylic monomer is not particularly limited, and various ones can be used.

Specific examples of the (meth)acrylate monomer include (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, isoamyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate hexadecyl (meth)acrylate, heptadecyl (meth)acrylate, stearyl (meth)acrylate, isostearyl (meth)acrylate, oleyl (meth)acrylate, behenyl (meth)acrylate, 2-decyltetradecanyl (meth)acrylate phenyl (meth)acrylate, toluyl (meth)acrylate, tolyl (meth)acrylate, 4-tert-butylcyclohexyl (meth)acrylate, dicyclopentenyl (meth)acrylate, dicyclopentenyloxyethyl (meth)acrylate, dicyclopentanyl (meth)acrylate, dicyclopentanyloxyethyl (meth)acrylate, isobornyl (meth)acrylate, tetrahydrofurfuryl (meth)acrylate, 3,3,5-trimethylcyclohexyl (meth)acrylate, adamantyl (meth)acrylate, 3-hydroxy-1-adamantyl (meth)acrylate, 1-methyladamantyl (meth)acrylate, 1-ethyladamantyl (meth)acrylate, 3,5-dihydroxy-1-adamantyl (meth)acrylate, benzyl (meth)acrylate, 2-methoxyethyl (meth)acylate, 2-butoxyethyl (meth)acrylate, 2-ethoxyethyl (meth)acrylate, 3-methoxypropyl (meth)acrylate, 3-methoxybutyl (meth)acrylate, phenoxyethyl (meth)acrylate, methylphenoxyethyl (meth)acrylate, m-phenoxybenzyl (meth)acrylate, ethylcarbitol (meth)acrylate, methoxy triethylene glycol (meth)acrylate, ethoxy diethylene glycol (meth)acrylate, 2-hydroxy-3-phenoxypropyl (meth)acrylate, 2-ethylhexyl diethylene glycol (meth)acrylate, methoxy-dipropylene glycol (meth)acrylate, 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, 1,4-cyclohexanedimethanol (meth)acrylate, glycerol (meth)acrylate, polyethylene glycol (meth)acrylate (Blemmer PE-90, PE-200, PE-350, PE-350G, AE-90, AE-200, AE-400 etc., manufactured by NOF Corporation), polypropylene glycol (meth)acrylate (Blemmer PP-500, PP-800, PP-1000, AP-150, AP-400, AP-550 etc., manufactured by NOF Corporation), polyethylene glycol-polypropylene glycol (meth)acrylate (Blemmer 50PEP-300, 70PEP-350B etc., manufactured by NOF Corporation), polyethylene glycol-polypropylene glycol (meth)acrylate, polyethylene glycol-polytetramethylene glycol (meth)acrylate, polypropylene glycol-polytetramethylene glycol (meth)acrylate, polyethylene glycol-polybutylene glycol (meth)acrylate, glycidyl (meth)acrylate, 4-hydroxybutyl-glycidyl ether (meth)acrylate, dimethylaminoethyl (meth)acrylate, 2-aminoethyl (meth)acrylate, diethylaminoethyl (meth)acrylate, a dimethylaminoethyl (meth)acrylate quaternary product (Light Ester DQ-100, DQ-75, etc., manufactured by Kyoeisha Chemical Co., Ltd.), 2-methyl-2-ethyl-1,3-dioxolane 4-(meth)acrylate, 1,4-dioxaspiro[4,5]dec-2-ylmethyl 2-meth)acrylate (CHDOL-10, manufactured by Osaka Organic Chemical Industry Ltd.), 3-ethyl-3-oxetanyl (meth)acrylate (OXE-10, manufactured by Osaka Organic Chemical Industry Ltd.), γ-butyrolactone (meth)acrylate, 2-phenylthioethyl (meth)acrylate, 2-hydroxy-3-(2-propenyloxy)propyl (meth)acrylate, a phthalic anhydride-2-hydroxypropyl (meth)acrylate adduct (Viscoat #2100, manufactured by Osaka Organic Chemical Industry Ltd.), 2-(meth)acryloyloxyethyl phthalic acid (Light Ester HPA-MPL manufactured by Kyoeisha Chemical Co., Ltd., CB-1 manufactured by Shin-Nakamura Chemical Co., Ltd., etc.), mono[1-methyl-2-[(1-oxo-2-propenyl)oxy]ethyl] 1,2-cyclohexyldicarboxylate (Viscoat #2150 manufactured by Osaka Organic Chemical Industry Ltd.), (meth)acryloyloxy-ethylhexahydrophthalate (Light Ester HO-HH, HOA-HH etc., manufactured by Kyoeisha Chemical Co., Ltd.), (meth)acryloyloxyethyl succinate (Light Ester HO-MS and HOA-MS manufactured by Kyoeisha Chemical Co., Ltd., SA and A-SA manufactured by Shin-Nakamura Chemical Co., Ltd, etc.), 2-(meth)acryloyloxyethyl-2-hydroxypropyl phthalic acid (Light Ester HO-MPP etc., manufactured by Kyoeisha Chemical Co., Ltd.), 2-(meth)acryloyloxyethyl-hydroxyethyl phthalic acid (HOA-MPE etc., manufactured by Kyoeisha Chemical Co., Ltd.), 2-(meth)acryloyloxyethyl-phosphate (Light Ester P-1M, P-2M, etc., manufactured by Kyoeisha Chemical Co., Ltd), ethoxylated-o-phenylphenol (meth)acrylate, methoxy polyethylene glycol (meth)acrylate, (Light Ester MC, 130MA, 041MA, MTG, MTG-A, and 130A, manufactured by Kyoeisha Chemical Co., Ltd., M-90G, AM-90G, M-230G, and AM 130G, manufactured by Shin-Nakamura Chemical Co., Ltd., Fancryl FA-400M manufactured by Hitachi Chemical Co., Ltd., Blemmer PME-100, PME-200, PME-400, PME-550, PME-1000, PME-4000, AME-400, etc. manufactured by NOF Corporation), phenoxy polyethylene glycol (meth)acrylate (LIGHT ACRYLATE P-200A manufactured by Kyoeisha Chemical Co., Ltd., AMP-20GY manufactured by Shin-Nakamura Chemical Co., Ltd, Blemmer PAE-50, PAE-100, AAE-50, and AAE-300 manufactured by NOF Corporation, Aronix M-101, M-102, etc. manufactured by Toagosei Co., Ltd., etc.), paracumylphenoxethyl (meth)acrylate, nonylphenoxy polyethylene glycol (meth)acrylate (LIGHT ACRYLATE NP-4EA and NP-8EA manufactured by Kyoeisha Chemical Co., Ltd., Fancryl FA-314A and FA-318A manufactured by Hitachi Chemical Co., Ltd., Blemmer ANE-1300 manufactured by NOF Corporation, M-111, M113, M-117, etc. manufactured by Toagosei Co., Ltd., etc.), octoxypolyethylene glycol-polypropylene glycol (meth)acylate, lauroxypolyethylene glycol (meth)acrylate, stearoxypolyethylene glycol (meth)acrylate, phenoxypolyethylene glycol-polypropylene glycol (meth)acrylate, nonylphenoxy-polyethylene glycol-polypropylene glycol (meth)acrylate, 3-chloro-2-hydroxypropyl (meth)acrylate, 2-(2-vinyloxyethoxy)ethyl (meth)acrylate, allyloxy polyethylene glycol-polypropylene glycol (meth)acrylate, undecylenoxy (meth)acrylate, undecylenoxy polyethylene glycol (meth)acrylate, ω-carboxy-polycaprolactone (meth)acrylate (M-5300 etc., manufactured by Toagosei Co., Ltd.), acrylic acid dimer (M-5600 manufactured by Toagosei Co., Ltd., β-CEA manufactured by Daicel-Cytec Co., Ltd., etc.), N-ethylmaleimide (meth)acrylate, pentamethylpiperidinyl (meth)acrylate, tetramethylpiperidinyl (meth)acrylate, γ-[(meth)acryloyloxypropyl]trimethoxysilane, γ-[(meth)acryloyloxypropyl]triethoxysilane, γ-[(meth)acryloyloxypropyl]methyldimethoxysilane, 2-isocyanate ethyl (meth)acrylate, 2-(O-[1′-methylpropylideneamino]carboxyamino)ethyl (meth)acrylate, 2-[(3,5-dimethylpyrazolyl)carbonylamino]ethyl (meth)acrylate, zinc (meth)acrylate, potassium (meth)acrylate, sodium (meth)acrylate, magnesium (meth)acylate, calcium (meth)acrylate, barium (meth)acrylate, strontium (meth)acrylate, nickel (meth)acrylate, copper (meth)acrylate, aluminum (meth)acrylate, lithium (meth)acrylate, neodymium(meth)acrylate, trifluoromethyl methyl (meth)acrylate, trifluoromethyl ethyl (meth)acrylate, 2,2,2-trifluoroethyl (meth)acrylate, 2,2,3,3-tetrafluoropropyl (meth)acrylate, 1H,1H,5H-octafluoropentyl (meth)acrylate, perfluoroethylmethyl (meth)acrylate, 2-perfluoroethylethyl (meth)acrylate, perfluoroethyl perfluorobutylmethyl (meth)acrylate, 2-perfluoroethyl-2-perfluorobutylethyl (meth)acrylate, perfluoroethyl (meth)acrylate, perfluoromethyl (meth)acrylate, diperfluoromethylmethyl (meth)acrylate, 2,2-diperfluoromethylethyl (meth)acrylate, perfluoromethylperfluoroethylmethyl (meth)acrylate, 2-perfluoromethyl-2-perfluoroethylethyl (meth)acrylate, 2-perfluorohexylmethyl (meth)acrylate, 2-perfluorohexylethyl (meth)acrylate, 2-perfluorodecylmethyl (meth)acrylate, 2-perfluorodecylethyl (meth)acrylate, 2-perfluorohexadecylmethyl (meth)acrylate, 2-perfluorohexadecylethyl (meth)acrylate, (meth)acrylamide, dimethyl (meth)acrylamide, diethyl (meth)acrylamide, (meth)acryloyl morpholine, hydroxyethyl (meth)acrylamide, isopropyl (meth)acrylamide, dimethylaminopropyl (meth)acrylamide, diacetone (meth)acrylamide, and the like.

These (meth)acrylic monomers may be used singly or a plurality of them may be copolymerized. Here, the term “(meth)acrylic” refers to acrylic and/or methacrylic (the same shall apply hereinafter).

The main chain of the (meth)acrylic polymer (I) with an average of at least 0.8 radically-crosslinkable groups in one or more embodiments of the present invention is preferably produced by mainly polymerizing an acrylic acid ester monomer from the viewpoint of ease of availability and handling of monomers, ease of polymerization, excellent properties such as flexibility and elongation at low temperature of cured products. Here. “mainly” means that 50 mol % or more, preferably 70 mol % or more, of the monomer units constituting the (meth)acrylic polymer (I) with an average of at least 0.8 radically-crosslinkable groups are acrylic acid ester monomers.

From the viewpoint of excellent heat resistance of the obtained cured product and good rubber elasticity, preferred acrylic acid ester monomers include acrylic acid alkyl ester monomers having a saturated hydrocarbon group, and specific examples thereof include ethyl acrylate, n-butyl acrylate, tert-butyl acrylate, 2-ethylhexyl acrylate, lauryl acrylate, stearyl acrylate, and isostearyl acrylate. Further, from the viewpoint of superiority in low temperature characteristics and good compatibility with the (meth)acrylate compound (III) having a rosin ester group as a component of one or more embodiments of the present application, examples of more preferred acrylic acid ester monomers include alkyl acrylate monomers containing a saturated hydrocarbon group having 4 to 22 carbon atoms and specific examples thereof include n-butyl acrylate, tert-butyl acrylate 2-ethylhexyl acrylate, lauryl acrylate, stearyl acrylate, and isostearyl acylate.

In one or more embodiments of the present invention, these preferable monomers may be copolymerized with other monomers or block-copolymerized with other monomers. Examples of the monomer to be copolymerized include styrene-based monomers such as styrene, vinyltoluene, α-methylstyrene, chlorostyrene, styrenesulfonic acid and salts thereof; fluorine-containing vinyl monomers such as perfluoroethylene, perfluoropropylene, and vinylidene fluoride; silicon-containing vinyl-based monomers such as vinyltrimethoxysilane and vinyltriethoxysilane; maleic anhydride, maleic acid, and monoalkyl esters and dialkyl esters of maleic acid; fumaric acid and monoalkyl esters and dialkyl esters of fumaric acid; maleimide-based monomers such as maleimide, methyl maleimide, ethyl maleimide, propyl maleimide, butyl maleimide, hexyl maleimide, octyl maleimide, dodecyl maleimide, stearyl maleimide, phenyl maleimide, and cyclohexyl maleimide; nitrile group-containing vinyl-based monomers such as acrylonitrile and methacrylonitrile; amide group-containing vinyl-based monomers such as acrylamide and methacrylamide; vinyl esters such as vinyl acetate, vinyl propionate, vinyl pivalate, vinyl benzoate, and vinyl cinnamate; alkenes such as ethylene and propylene; conjugated dienes such as butadiene and isoprene; vinyl chloride, vinylidene chloride, allyl chloride, allyl alcohol, and the like.

A molecular weight distribution of the (meth)acrylic polymer (I) with an average of at least 0.8 radically-crosslinkable groups in one or more embodiments of the present invention, that is, a ratio (Mw/Mn) of the weight average molecular weight (Mw) to the number average molecular weight (Mn), both measured by gel permeation chromatography (GPC), is not particularly limited, but is preferably less than 1.8, more preferably 1.7 or less, even more preferably 1.6 or less, still even more preferably 1.5 or less, particularly preferably 1.4 or less, and most preferably 1.3 or less. When the molecular weight distribution is too large, not only the viscosity tends to increase to be difficult for handling, but also it tends to become difficult to control the mechanical properties and temperature characteristics of the obtained curable composition and cured product. In the GPC measurement in one or more embodiments of the present invention, chloroform is used as a mobile phase, measurement is carried out with a polystyrene gel column, and the number average molecular weight and the like can be obtained in terms of polystyrene.

A number average molecular weight of the (meth)acrylic polymer (I) with an average of at least 0.8 radically-crosslinkable groups in one or more embodiments of the present invention is not particularly limited, but it is preferably from 500 to 1,000,000, more preferably from 1,000 to 100,000, even more preferably from 5,000 to 100,000 when measured by GPC. When such a molecular weight is too low, flexibility of the cured product is impaired and thus elongation is reduced to result in failure to obtain sufficient elastomer elasticity. On the other hand, when the molecular weight is too high, the viscosity tends to be high and the handling tends to be difficult.

<Synthesis Method of (Meth)Acrylic Polymer (I) with Average of at Least 0.8 Radically-Crosslinkable Groups>

The (meth)acrylic polymer (1) with an average of at least 0.8 radically-crosslinkable groups used in one or more embodiments of the present invention can be obtained by various polymerization methods and is not particularly limited. However, radical polymerization methods are preferred from the viewpoint of versatility of monomers and ease of control, etc. Among the radical polymerization methods, controlled radical polymerization is more preferable. This controlled radical polymerization method can be classified into a “chain transfer agent method” and a “living radical polymerization method”. The living radical polymerization, in which the molecular weight and molecular weight distribution of the resulting (meth)acrylic polymer is easy to control, is more preferred, and atom transfer radical polymerization is particularly preferable from the viewpoint of availability of raw materials and ease of introduction of a functional group into the polymer terminal.

The living radical polymerization is radical polymerization which is maintained without losing the activity of the polymerization terminal. In the narrow sense, the living polymerization refers to polymerization in which the terminal always keeps its activity, but in general, also includes pseudo-living polymerization in which inactivity of the polymerization terminal and activity of the polymerization terminal are in equilibrium. The definition in the present disclosure is also the latter. The living radical polymerization has been positively studied in various groups in recent years. Examples thereof include methods using radical scavengers such as cobalt porphyrin complex (J. Am. Chem. Soc. 1994, 116, 7943) and nitroxide compounds (Macromolecules, 1994, 27, 7228), Atom Transfer Radical Polymerization (ATRP) using an organic halide compound. etc. as an initiator and a transition metal complex as a catalyst (J. Am. Chem. Soc. 1995, 117, 5614), and Single Electron Transfer (SET) Polymerization and the like. The atom transfer radical polymerization and the single electron transfer polymerization are generally carried out using as an initiator an organic halide or a sulfonyl halide compound or the like and as a catalyst a copper complex having copper as a central metal. (See, for example, Percec, V et al., J. Am. Chem. Soc. 2006, 128, 14156, JPS Chem 2007, 45, 1607). Further, AGET ((Macromolecules 2005, 38, 4139) and ARGET (Macromolecules 2006, 39, 39) that use a reducing agent in combination for these systems, and ICAR (PNAS. 2006, 103, 15309) that uses a thermally degradable or photodegradable radical generator in combination are also included in the scope of one or more embodiments of the present invention. In one or more embodiments of the present invention, a reducing agent and a thermally degradable or photodegradable radical generator may also be used in combination.

The radical polymerization, the controlled radical polymerization, the chain transfer agent method, the living radical polymerization method, and the atom transfer radical polymerization are known polymerization methods, but each of these polymerization methods is described in, for example, JP-A-2005-232419, JP-A-2006-291073 or the like, and they can be referred to.

The atom transfer radical polymerization, which is one of preferred methods for synthesizing the (meth)acrylic polymer (1) with an average of at least 0.8 radically-crosslinkable groups in one or more embodiments of the present invention, will be briefly described below.

In the atom transfer radical polymerization, it is preferable that an organic halide, particularly an organic halide having a highly reactive carbon-halogen bond (for example, a carbonyl compound having a halogen at the a-position or a compound having a halogen at the benzyl position), or a halogenated sulfonyl compound or the like is used as an initiator.

In order to obtain a (meth)acrylic polymer having two or more radically-crosslinkable groups in one molecule, it is preferable to use an organic halide or a halogenated sulfonyl compound having two or more starting points as an initiator.

The (meth)acrylic monomer used in the atom transfer radical polymerization is not particularly limited, and all of the exemplified (meth)acrylic monomers can be preferably used.

The transition metal complex to be used as a polymerization catalyst is not particularly limited, but is preferably a metal complex having a group 7, 8, 9, 10, or 11 element of the periodic table as a central metal, more preferably a transition metal complex having 0 valent copper, monovalent copper, divalent copper, divalent ruthenium, divalent iron or divalent nickel as the central metal, particularly preferably a copper complex. Specific examples of the monovalent copper compound used to form a copper complex include cuprous chloride, cuprous bromide, cuprous iodide, cuprous cyanide, cuprous oxide, cuprous perchlorate, and the like. Specific examples of the divalent copper compound include cupric chloride, cupric bromide, cupric iodide, cupric cyanide, cupric oxide, cupric perchlorate, cupric sulfide, and the like.

In the case of using a copper compound, a polyamine or the like is added as a ligand for enhancing catalytic activity. Examples of the polyamine compound include, but are not limited to, 2,2-bipyridine, 1,10-phenanthroline and a derivative thereof, an alkylamine (e.g., tributylamine), tetramethylethylenediamine, pentamethyldiethylenetriamine, hexamethyltriethylenetetraamine and hexamethyltris(2-aminoethyl)amine ethylenediamine. N,N′-hexamethylethylenediamine, 4,4′-di-(5-nonyl)-2,2′-bipyridine, N-(n-propyl)pyridylmethanimine, N-(n-octyl)pyridylmethanimine, diethylenetriamine, N,N,N′,N″,N″-pentamethyldiethylenetriamine, N-propyl-N,N-di(2-pyridylmethyl)amine, tris(2-aminoethyl)amine, tris[2-(dimethylamino)ethyl]amine, N,N-bis(2-dimethylaminoethyl)-N,N′-dimethylethylenediamine, 2,5,9,12-tetramethyl-2,5,9,12-tetraazatetradecane, 2,6,9,13-tetramethyl-2,6,9,13-tetraazatetradecane, 4,11-dimethyl-1,4,8,11-tetraazabicyclohexadecane, N′,N″-dimethyl-N′,N″-bis((pyridin-2-yl)methyl)ethane-1,2-diamine, tris[(2-pyridyl)methyl]amine, 2,5,8,12-tetramethyl-2,5,8,12-tetraazatetradecane, triethylenetetramine, N,N,N′,N″,N′″N′″-hexamethyltriethylenetetramine, N,N,N′,N′-tetrakis(2-pyridylmethyl)ethylenediamine, polyethylenimine and the like. These ligands may be used singly or two or more kinds thereof may be used in combination.

When AGET or ARGET is used as the present living radical polymerization, a reducing agent may be used. Such reducing agents are exemplified below, but are not limited to these reducing agents.

Metals: Specific examples thereof include alkaline metals such as lithium, sodium and potassium; alkaline earth metals such as beryllium, magnesium, calcium and barium; typical metals such as aluminum and zinc; and transition metals such as copper, nickel, ruthenium and iron. Moreover, these metals may be in the form of alloys (amalgams) with mercury.

Metal compounds: Specific examples thereof include salts of typical metals or transition metals, salts with typical elements, and complexes coordinated with carbon monoxide, olefins, nitrogen-containing compounds, oxygen-containing compounds, phosphorus-containing compounds, sulfur-containing compounds or the like. Specific examples include compounds of metals and ammonia/amines, titanium trichloride, titanium alkoxide, chromium chloride, chromium sulfate, chromium acetate, iron chloride, copper chloride, copper bromide, tin chloride, zinc acetate, zinc hydroxide, carbonyl complexes such as Ni(CO)₄ and Co₂CO₈, olefin complexes such as [Ni(cod)₂], [RuCh₂(cod)] and [PtCl₂(cod)] (wherein cod represents cyclooctadiene), and phosphine complexes such as [RhCl(P(CH₆H₅)₃)₃], RuCl₂ (P(C₆H₅)₃)₂] and [PtCl₂(P(C₆H₅)₃)₂].

Metal hydrides: Specific examples thereof include sodium hydride; germanium hydride; tungsten hydride; aluminum hydrides such as diisobutylaluminum hydride, lithium aluminum hydride, sodium aluminum hydride, sodium triethoxyaluminum hydride and sodium bis(2-methoxyethoxy)aluminum hydride; and organic tin hydrides such as triphenyltin hydride, tri-n-butyltin hydride, diphenyltin hydride, di-n-butyltin hydride, triethyltin hydride, trimethyltin hydride, and the like.

Organic tin compounds: Specific examples thereof include tin octylate, tin 2-ethylhexylate, dibutyltin diacetate, dibutyltin dilaurate, dibutyltin mercaptide, dibutyltin thiocarboxylate, dibutyltin dimaleate, dioctyltin thiocarboxylate, and the like.

Silicon hydrides: Specific examples thereof include trichlorosilane, trimethylsilane, triethylsilane, diphenylsilane, phenylsilane, polymethylhydrosiloxane, and the like.

Borohydrides: Specific examples thereof include borane, diborane, sodium borohydride, sodium trimethoxyborohydride, sodium borohydride sulfide, sodium cyanoborohydride, lithium cyanoborohydride, lithium borohydride, lithium triethylborohydride, lithium tri-s-butylborohydride, lithium tri-t-butylborohydride, calcium borohydride, potassium borohydride, zinc borohydride, tetra-n-butylammonium borohydride, and the like.

Nitrogen compounds: Specific examples thereof include hydrazine, diimide, and the like.

Phosphorus and phosphorous compounds: Specific examples thereof include phosphorus, phosphine, trimethylphosphine, triethylphosphine, triphenylphosphine, trimethyl phosphite, triethyl phosphite, triphenyl phosphite, hexamethylphosphorous triamide, hexaethylphosphorous triamide, and the like.

Sulfur and sulfur compounds: Specific examples thereof include sulfur, rongalites, hydrosulfites, thiourea dioxide, and the like. Rongalites refer to formaldehyde derivatives of sulfoxylates and are represented by the formula MSO₂.CH₂O (where M represents Na or Zn). Specific examples thereof include sodium formaldehyde sulfoxylate, zinc formaldehyde sulfoxylate, and the like. Hydrosulfites refer to the generic term for sodium hyposulfite and formaldehyde derivatives of sodium hyposulfite.

Hydrogen.

Organic compounds showing reduction action: Specific examples thereof include alcohols, aldehydes, phenols, organic acid compounds and the like. Examples of the alcohols include methanol, ethanol propanol, isopropanol and the like. Examples of the aldehyde include formaldehyde, acetaldehyde, benzaldehyde, formic acid and the like. Examples of the phenol include phenol, hydroquinone, dibutylhydroxytoluene, tocopherol and the like. Examples of the organic acid compound include citric acid, ascorbic acid, salts and esters thereof, and the like.

These reducing agents may be used singly or two or more kinds thereof may be used in combination.

From the viewpoint of the polymerization rate and structure control, an addition amount of the reducing agent is preferably 0.01 to 100 molar equivalents, more preferably 0.1 to 40 molar equivalents, even more preferably 0.5 to 10 molar equivalents, based on the transition metal compound.

<Basic Compound>

When AGET or ARGET is used as the present living radical polymerization, a basic compound may be used. Such basic compounds are exemplified below, but are not limited to these basic compounds. The basic compounds may be compounds having a property of accepting protons, which fall under the definition of Bronsted's base, or compounds which fall under the definition of a base of Lewis, have an unshared electron pair, and have properties capable of forming a coordinate bond with the unshared electron pair as a donor group.

Examples of the basic compound include amine derivatives such as ammonia, methylamine, dimethylamine, trimethylamine, triethylamine, and aniline; polyamine derivatives such as ethylenediamine, propylenediamine, tetramethylethylenediamine, diethylenetriamine, pentamethyldiethylenetriamine, triethylenetetramine, hexamethyltriethylenetetramine, and hexamethylenetetramine; nitrogen-containing heterocyclic compounds such as pyridine, bipyridine, piperidine, pyrrole, and imidazole; organometallic compounds such as sodium methoxide, sodium ethoxide, sodium propoxide, sodium butoxide, sodium pentoxide, sodium hexoxide, potassium methoxide, potassium ethoxide, potassium propoxide, potassium butoxide, potassium pentoxide, potassium hexoxide, methyllithium, ethyllithium, propyllithium, butyllithium, pentyllithium, and hexyllithium; hydroxides such as sodium hydroxide, potassium hydroxide, calcium hydroxide, magnesium hydroxide, aluminum hydroxide, and ammonium hydroxide; weak acid salts such as sodium carbonate, potassium carbonate, calcium carbonate, magnesium carbonate, aluminum carbonate, ammonium carbonate, sodium hydrogen carbonate, potassium hydrogen carbonate, calcium hydrogen carbonate, magnesium hydrogen carbonate, aluminum hydrogen carbonate, ammonium hydrogen carbonate, sodium phosphate, sodium hydrogen phosphate, sodium acetate, and potassium acetate. These basic compounds may be used singly or two or more kinds thereof may be used in combination.

Further, the basic compound may be directly added to the reaction system or may be generated in the reaction system.

From the viewpoint of polymerization rate and structure control, an addition amount of the basic compound is preferably 0.01 to 400 molar equivalents, more preferably 0.1 to 150 molar equivalents, even more preferably 0.5 to 40 molar equivalents, based on the transition metal compound.

The polymerization reaction can be carried out in the absence of a solvent, but it can also be carried out in various solvents. The kind of the solvent is not particularly limited, and the solvent described in paragraph [0067] of JP-A-2005-232419 can be mentioned. These may be used singly, or two or more thereof may be used in combination. Polymerization can also be carried out in an emulsion system or a system including a supercritical fluid CO₂ as a medium.

The polymerization temperature is not limited, but the polymerization can be carried out in the range of 0 to 200° C., preferably in the range of room temperature to 150° C.

<Radically-Crosslinkable Group>

Next, the radically-crosslinkable groups in the (meth)acrylic polymer (I) with an average of at least 0.8 radically-crosslinkable groups will be described.

Any functional groups as the radically-crosslinkable group are not particularly limited as long as they have a radically-crosslinkable carbon-carbon double bond. In addition, when rubber-like properties are particularly required for the cured product of one or more embodiments of the present invention, since the molecular weight between crosslinking points which greatly affect rubber elasticity can be taken large, the (meth)acrylic polymer (I) preferably has at least one radically-crosslinkable carbon-carbon double bond at the terminal of the molecular chain. More preferably, the (meth)acrylic polymer (I) has all radically-crosslinkable carbon-carbon double bonds at the molecular chain terminals.

As the radically-crosslinkable group, a polymerizable carbon-carbon double bond group including a (meth)acryloyl group, a vinyl group, an allyl ether group, and the like can be mentioned. Among them, in the case of the (meth)acrylic polymer produced by the atom transfer radical polymerization method described above, the radically-crosslinkable group is preferably a (meth)acryloyl group because of its easy introduction.

The method of introducing the (meth)acryloyl group will be explained. For introduction of the (meth)acryloyl group, known methods can be used. For example, the methods described in paragraphs [0080] to [0091] of JP-A-2004-203932 are mentioned. Among these methods, from the viewpoint of easier control compounds obtained by substituting a terminal halogen group in a (meth)acrylic polymer with a compound having a (meth) acryloyl group are preferred. The (meth)acrylic polymer having a terminal halogen group can be produced by a method of polymerizing a (meth)acrylic monomer using the organic halide or halogenated sulfonyl compound as an initiator and a transition metal complex as a catalyst, or a method of polymerizing a (meth)acrylic monomer using a halogen compound as a chain transfer agent, but the former method is preferred.

The compound having a (meth)acryloyl group is not particularly limited, but a compound represented by the following general formula (1) can be used.

M⁺⁻OC(O)C(R)═CH₂ (1)

Specific examples of R in the above formula (1) include, —H, —CH₃, —CH₂CH₃, —(CH₂)ₙH₃ (n represents an integer of 2 to 19), —C₆H₅, —CH₂OH, —CN, and the like, among which —H and —CH₃ are preferable.

In the formula (1), M⁺ is a counter cation of the oxyanion, and examples of the kind of M⁺ include alkali metal ions, specifically, a lithium ion, a sodium ion, a potassium ion, and a quaternary ammonium ion. Examples of the quaternary ammonium ion include tetramethylammonium ion, tetraethylammonium ion, tetrabenzylammonium ion, trimethyldodecylammonium ion, tetrabutylammonium ion, dimethylpiperidinium ion and the like, and from the viewpoint of reactivity and ease of availability, sodium ion and potassium ion are preferred.

A use amount of the oxy anion in the general formula (1) is preferably 1 to 5 equivalents, more preferably 1.0 to 1.2 equivalents, relative to the halogen group. Since this reaction proceeds almost quantitatively, when the amount of the oxyanion is too small, a sufficient amount of (meth)acryloyl group with respect to the halogen group is not introduced, and when the amount is too much, such addition is economically not preferable.

A solvent for carrying out this reaction is not particularly limited, but since the reaction is a nucleophilic substitution reaction, a polar solvent is preferable, and examples thereof to be used include tetrahydrofuran, dioxane, diethyl ether, acetone, dimethylsulfoxide, dimethylformamide, dimethylacetamide, hexamethylphosphoric triamide, acetonitrile, and the like.

The temperature at which the reaction is carried out is not limited, but the reaction is generally carried out at 0 to 150° C., preferably at room temperature to 100° C. to retain a polymerizable terminal group.

The number of radically-crosslinkable groups in one molecule of the (meth) acrylic polymer (I) may be the same as each other or different from each other. From the viewpoint of curability of the polymer (I) and physical properties such as flexibility, elongation and tensile strength of the cured product, the (meth)acrylic polymer (I) has an average of at least 0.8 radically-crosslinkable groups, preferably 0.9 or more and 4.0 or less radically-crosslinkable groups, more preferably 1.0 or more and 2.0 or less radically-crosslinkable groups in one molecule, although not particularly limited.

In the case of using a mixture of a plurality of (meth)acrylic polymers (I) having different kinds of radically-crosslinkable groups, an average value of the number of radically-crosslinkable groups included in the plurality of (meth)acrylic polymers is the number of radically-crosslinkable groups in the (meth)acrylic polymer (I).

When rubber-like properties are particularly required for the cured product of one or more embodiments of the present invention, since the molecular weight between crosslinking points which greatly affect rubber elasticity can be taken large, the (meth)acrylic polymer (I) preferably has at least one (meth)acryloyl group at the terminal of the molecular chain. More preferably, the (meth)acrylic polymer (I) has all (meth)acryloyl groups at the molecular chain terminals.

When the cured product of one or more embodiments of the present invention is required to have more flexible properties, the (meth)acrylic polymer (I) preferably contains a (meth)acrylic polymer having (meth)acryloyl groups at both terminals of its molecular chain and a (meth)acrylic polymer having a (meth)acryloyl group at one terminal of its molecular chain. When the (meth)acrylic polymer having (meth)acryloyl groups at both terminals and the (meth)acrylic polymer having a (meth)acryloyl group at one terminal are mixed, it is preferred to add 0 to 3000 parts by weight of the (meth)acrylic polymer having a (meth)acryloyl group at one terminal to 100 parts by weight of the (meth)acrylic polymer having (meth)acryloyl groups at both terminals. The less the amount of the (meth)acrylic polymer having a (meth)acryloyl group at one terminal is, the harder the cured material becomes. Conversely, the more the amount of the (meth)acrylic polymer having a (meth)acryloyl group at one terminal is, the softer and more excellent in elongation the cured product becomes.

### <Radical Polymerization Initiator (II)>

The radical polymerization initiator (HI) is not particularly limited, but a radical photoinitiator is preferable when curing is carried out by active energy rays such as UV or electron beam, and a thermal radical initiator is preferable when curing is carried out by heat. In recent years, it is preferable to use a radical photoinitiator for curing with active energy rays such as UV or electron beam, in view of the fact that less energy is required for curing and the working environment can be kept satisfactory.

<Radical Photoinitiator>

The radical photoinitiator is not particular limited, but examples of the radical photoinitiator include acetophenone, propiophenone, benzophenone, xanthol, fluoreine, benzaldehyde, anthraquinone, triphenylamine, carbazole, 3-methylacetophenone, 4-methylacetophenone, 3-pentylacetophenone, 2,2-diethoxyacetophenone, 4-methoxyacetophenone, 3-bromoacetophenone, 4-allylacetophenone, p-diacetylbenzene, 3-methoxybenzophenone, 4-methylbenzophenone, 4-chlorobenzophenone, 4,4′-dimethoxybenzophenone, 4-chloro-4′-benzlbenzophenone, 3-chloroxanthone, 3,9-dichloroxanthone, 3-chloro-8-nonylxanthone, benzoin, benzoin methyl ether, benzoin butyl ether, bis(4-dimethylaminophenyl) ketone, benzyl methoxy ketal, 2-chlorothioxanthone, 2,2-dimethoxy-1,2-diphenylethan-1-one (trade name: IRGACURE 651, manufactured by BASF Japan), 1-hydroxy-cyclohexyl-phenyl-ketone (trade name: IRGACURE 184, manufactured by BASF Japan), 2-hydroxy-2-methyl-1-phenyl-propan-1-one (trade name: DAROCUR 1173, manufactured by BASF Japan), 1-[4-(2-hydroxyethoxy)-phenyl]-2-hydroxy-2-methyl-1-propan-1-one (trade name: IRGACURE 2959, manufactured by BASF Japan), 2-methyl-1-[4-methylthio)phenyl]-2-morpholinopropan-1-one (trade name: IRGACURE 907, manufactured by BASF Japan), 2-benzyl-2-dimethylamino-1-(4-morpholinophenyl)-butanone-1 (trade name: IRGACURE 369, manufactured by BASF Japan), 2-(4-methylbenzyl)-2-dimethylamino-1-(4-morpholin-4-yl-phenyl)-butan-1-one (trade name: IRGACURE 379, manufactured by BASF Japan), dibenzoyl, and the like.

Among these radical photoinitiators, α-hydroxyketone compounds (e.g., benzoin, benzoin methyl ether, benzoin butyl ether, 1-hydroxy-cyclohexyl-phenyl-ketone, etc.), and phenyl ketone derivatives (e.g., acetophenone, propiophenone, benzophenone, 3-methylacetophenone, 4-methylacetophenone, 3-pentylacetophenone, 2,2-diethoxyacetophenone, 4-methoxyacetophenone, 3-bromoacetophenone, 4-allylacetophenone, 3-methoxybenzophenone, 4-methylbenzophenone, 4-chlorobenzophenone, 4,4′-dimethoxybenzophenone, 4-chloro-4′-benzoylbenzophenone, bis(4-dimethylaminophenyl) ketone, etc.) are preferable.

Further, examples of an initiator species capable of suppressing oxygen inhibition on the surface of a cured product include radical photoinitiators having two or more photodegradable groups in the molecule, such as 2-hydroxy-1-[4-[4-(2-hydroxy-2-methyl-propionyl)benzyl]phenyl]-2-methyl-propan-1-one (trade name: IRGACURE 127, manufactured by BASF Japan), 1-[4-(4-benzoxylphenylsulfanyl)phenyl]-2-methyl-2-(4-methylphenylsulfonyl)propan-1-one (trade name: ESURE 1001M), methyl benzoylformate (trade name: SPEEDCURE MBF, manufactured by LAMBSON Ltd.). O-ethoxyimino-1-phenylpropan-1-one (trade name: SPEEDCURE PDO, manufactured by LAMBSON Ltd.), and oligo[2-hydroxy-2-methyl-[4-(1-methylvinyl) phenyl]propanone (trade name: ESCURE KIP150, manufactured by LAMBERTI Group), and hydrogen abstraction type radical photoinitiators having three or more aromatic rings in the molecule, such as 1-[4-(phenylthio)-,2-(O-benzoyloxime)] 1,2-octanedione (trade name: IRGACURE OXE 01, manufactured by BASF Japan), 1-[9-ethyl-6-(2-methylbenzoyl)-9H-carbazol-3-yl]-1-(O-acetyloxime) ethanone (trade name: IRGACURE OXE 02, manufactured by BASF Japan), 4-benzoyl-4′-methyldiphenyl sulfide, 4-phenylbenzophenone, 4,4′,4″-(hexamethyltriamino)triphenylmethane, and the like. Further, examples thereof include acylphosphine oxide-based radical photoinitiators characterized by deep curability improvement, such as 2,4,6-trimethylbenzoyl-diphenyl-phosphine oxide (trade name: DAROCUR TPO, manufactured by BASF Japan), bis(2,4,6-trimethylbenzyl)-phenylphosphine oxide (trade name: IRGACURE 819, manufactured by BASF Japan), bis(2,6-dimethylbenzoyl)-2,4,4-trimethyl-pentylphosphine oxide, and the like.

From the viewpoint of the balance between curability and storage stability of the curable composition of one or more embodiments of the present invention, preferred radical photoinitiators are 1-hydroxy-cyclohexyl-phenyl-ketone (trade name: IRGACURE 184, manufactured by BASF Japan), 2-hydroxy-2-methyl-1-phenyl-propan-1-one (trade name: DAROCUR 1173, manufactured by BASF Japan), bis(4-dimethylaminophenyl)ketone, 2-hydroxy-1-[4-[4-(2-hydroxy-2-methyl-propionyl)-benzyl]phenyl]-2-methyl-propan-1-one (trade name: IRGACURE 127, manufactured by BASF Japan), 2-benzyl-2-dimethylamino-1-(4-morpholinophenyl)-butanone-1 (trade name: IRGACURE 369, manufactured by BASF Japan), 2-(4-methylbenzyl)-2-dimethylamino-1-(4-morpholin-4-yl-phenyl)-butan-1-one (trade name: IRGACURE 379, manufactured by BASF Japan), 2,4,6-trimethylbenzoyl-diphenyl-phosphine oxide (trade name: DAROCUR TPO, manufactured by BASF Japan), bis(2,4,6-trimethylbenzoyl)-phenylphosphine oxide (trade name: IRGACURE 819, manufactured by BASF Japan), and bis(2,6-dimethylbenzoyl)-2,4,4-trimethyl-pentylphosphine oxide.

These radical photoinitiators may be used singly or in admixture of two or more thereof or in combination with other compounds.

Specific examples of the combination of the radical photoinitiator with other compounds include a combination with an amine such as 4,4′-bis(dimethylamino)benzophenone, 4,4′-bis (diethylamino)benzophenone, diethanolmethylamine, dimethylethanolamine, triethanolamine, ethyl-4-dimethylaminobenzoate, and 2-ethylhexyl-4-dimethylaminobenzoate; a combination of this combination further combined with a iodonium salt such as diphenyliodonium chloride; and a combination with an amine and a colorant such as methylene blue.

When the radical photoinitiator is used, a polymerization inhibitor such as hydroquinone, hydroquinone monomethyl ether, benzoquinone, para-tertiary butylcatechol, 2,2,6,6-tetramethylpiperidine-1-oxyl, N,N-dialkylhydroxylamine (e.g., N,N-diethylhydroxylamine, N,N-distearylhydroxylamine, etc.), and the like may be added thereto as needed.

<Thermal Radical Initiator>

The thermal radical initiator is not particularly limited, but includes an azo initiator, a peroxide initiator, a persulfate initiator, and a redox initiator. Examples of suitable azo initiators include, but are not limited to, 2,2′-azobis(4-methoxy-2,4-dimethylvaleronitrile) (VAZO 33), 2,2′-azobis(2-amidinopropane) dihydrochloride (VAZO 50), 2,2′-azobis(2,4-dimethylvaleronitrile) (VAZO 52), 2,2′-azobis(isobutyronitrile) (VAZO 64), 2,2′-azobis-2-methylbutyronitrile (VAZO 67), 1,1-azobis(l-cyclohexanecarbonitrile) (VAZO 88) (all available from DuPont Chemical), 2,2′-azobis(2-cyclopropylpropionitrile), and 2,2′-azobis(methylisobutyrate) (V-601) (available from Wako Pure Chemical Industries, Ltd), and the like.

Examples of suitable peroxide initiators include, but are not limited to, benzoyl peroxide, acetyl peroxide, lauroyl peroxide, decanoyl peroxide, dicetyl peroxydicarbonate, di(4-t-butylcyclohexyl) peroxydicarbonate (Perkadox 16S) (available from Akzo Nobel), di(2-ethylhexyl) peroxydicarbonate, t-butyl peroxypivalate (Lupersol 11) (available from Elf Atochem), t-butyl peroxy-2-ethyl hexanoate (Trigonox 21-C50) (available from Akzo Nobel), dicumyl peroxide, and the like.

Examples of suitable persulfate initiators include, but are not limited to, potassium persulfate, sodium persulfate, and ammonium persulfate.

Examples of suitable redox (oxidation and reduction) initiators include, but are not limited to, a combination of the persulfate initiator and a reducing agent such as sodium metabisulfite and sodium bisulfite; a combination of an organic peroxide and a tertiary amine-based system, such as a system based on benzoyl peroxide and dimethylaniline; and a system based on an organic hydroperoxide and a transition metal, such as a system based on cumene hydroperoxide and cobalt naphthate.

Examples of other initiators include, but are not limited to, pinacols such as tetraphenyl 1,1,2,2-ethanediol, and the like.

The thermal radical initiator is preferably selected from the group consisting of azo initiators and peroxide initiators. Further preferred are 2,2′-azobis(methylisobutyrate), benzoyl peroxide, dicumyl peroxide, t-butyl peroxypivalate and di(4-t-butylcyclohexyl) peroxydicarbonate, and a mixture of these.

Also, in some cases, a radical photoinitiator and a thermal radical initiator may be used in combination.

The radical polymerization initiator used in one or more embodiments of the present invention is present in a catalytically effective amount, and although such an amount is not limited, from the viewpoint of curability and storage stability, the amount is preferably 0.01 to 10 parts by weight, more preferably about 0.1 to 5 parts by weight, based on 100 parts by weight of the (meth)acrylic polymer (I) with an average of at least 0.8 radically-crosslinkable groups according to one or more embodiments of the present invention. When a mixture of initiators is used, the above-mentioned addition amount is preferably used as the total amount of the mixture of initiators.

<(Meth)Acrylate Compound (III) Having Rosin Ester Group>

The (meth)acrylate compound (III) having a rosin ester group of one or more embodiments of the present invention can be used without any limitation as long as the compound (m) is a compound in which a rosin skeleton derived from abietic acid or the like and a (meth)acryloyl group are bonded via an ester group in one molecule. Here, the rosin skeleton refers to a skeleton moiety obtained by removing a carboxyl group from abietic acid, neoabietic acid, palustric acid, levopimaric acid, maleopimaric acid, dihydroabietic acid, tetrahydroabietic acid, dehydroabietic acid or the like.

Rosin is a natural product, and it is a mixture of plural kinds of isomers mainly composed of abietic acid. By subjecting these rosins to various modification processes such as hydrogenation, isomerization, dehydrogenation and the like as appropriate, it is possible to obtain abietic acid, neoabietic acid, palustric acid, levopimaric acid, maleopimaric acid, dihydroabietic acid, tetrahydroabietic acid, dehydroabietic acid, dehydroabietic acid glycidyl ester, etc. (hereinafter referred to as rosins). These rosins are used as a raw material of a rosin ester group, and a carboxyl group contained in these raw materials and a (meth)acrylate compound having an epoxy group, such as glycidyl (meth)acylate or 3,4-epoxycyclohexylmethyl (meth)acrylate, are reacted to introduce a (meth)acryloyl group into the rosin skeleton, so that it is possible to obtain a (meth)acrylate compound (III) having a rosin ester group. It is also possible to obtain a (meth)acrylate compound (III) having a rosin ester group by reacting an epoxy group contained in rosins with acrylic acid, acrylic chloride or the like to introduce a (meth)acryloyl group. Furthermore, by reacting a carboxyl group contained in rosins with a hydroxyalkyl (meth)acrylate such as hydroxyethyl (meth)acrylate, hydroxypropyl (meth)acrylate or the like, a (meth)acrylate compound (II) having a rosin ester group can also be obtained. Examples of a commercially available product of such a (meth)acrylate compound (m) having a rosin ester group include BEAMSET 101, that is 1-acrylic acid-3-dehydroabietic acid-2-hydroxypropyl manufactured by Arakawa Chemical Industries, Ltd.

The number of the rosin ester group and the (meth) acryloyl group contained in one molecule of the (meth)acrylate compound (HI) having a rosin ester group may be each one, or either or both of such groups may be plural. These compounds can be obtained by, for example, reacting a rosin compound having a carboxyl group, acrylic acid, etc. mainly with a compound having a plurality of hydroxyl groups such as glycerol, trimethylolpropane, pentaerythritol, and the like. Alternatively, a combination use of a dicarboxylic acid such as succinic anhydride, phthalic anhydride or the like can afford a compound having a larger number of functional groups.

In any of these methods, a compound having both of at least one rosin ester group and at least one (meth)acryloyl group contained in one molecule exhibits the effect of one or more embodiments of the present invention, but among these compounds, from the viewpoint of excellent UV curability and excellent appearance of the obtained cured product, a compound obtained from rosin that is refined and less colored is preferable. Further, from the viewpoint of easy availability and easy handling, 1-acrylic acid-3-dehydroabietic acid-2-hydroxypropyl is most preferred.

The (meth)acrylate compound (III) having a rosin ester group of one or more embodiments of the present invention may be used singly or in combination of two or more kinds thereof.

An amount of the (meth)acrylic acid ester monomer (II) used in one or more embodiments of the present invention is preferably 10 to 100 parts by weight, more preferably 10 to 70 parts by weight, even more preferably 10 to 50 parts by weight, based on 100 parts by weight of the (meth)acrylic polymer (I) with an average of at least 0.8 radically-crosslinkable groups. When the amount of the monomer (III) is less than 10 parts by weight, the effect of improving the dynamic viscoelastic properties of the obtained cured product is poor, whereas when the amount exceeds 100 parts by weight, the curability may deteriorate, or the tackiness and heat resistance of the obtained cured product may be worse in some cases. The lower limit value of the amount is more preferably 15 parts by weight or more, and even more preferably 20 parts by weight or more. The upper limit is particularly preferably 40 parts by weight or less.

JP-A-8-143635 discloses an active energy ray-curable resin composition that includes a rosin epoxy acrylate which is a component of one or more embodiments of the present application and a polyurethane resin having a carbon-carbon unsaturated group and that shows excellent adhesion to an olefinic resin. However, there is no description about the influence on the viscoelastic properties of the obtained cured product, and those skilled in the art cannot predict what kind of effects on the viscoelastic properties will be obtained. In fact, for polyurethane acrylate resin, the effect of obtaining high tan δ in a wide temperature range cannot be achieved. Additionally, the compatibility may decrease in the presence of a high molecular weight component such as a polyurethane resin having a carbon-carbon unsaturated group.

JP-A-2010-106191 discloses an active energy ray-curable resin composition that contains (meth)acryloyl group-containing rosins and polyfunctional (meth)acrylates and that is excellent in adhesion to a polyolefin, and describes that the composition exhibits functions such as pigment dispersibility, coating gloss, water resistance, and emulsification resistance, and is suitable for various adhesives, vanishes, binders, pressure-sensitive adhesives, and the like. However, there is no description about the effect on the viscoelastic properties of the obtained cured product, and only low molecular weight polyfunctional monomers are disclosed as the polyfunctional (meth)acrylates, so that it is clear that the obtained cured product is not viscous and has extremely high hardness. Thus, those skilled in the art cannot predict what kind of effects on the (meth)acrylic polymer (I) with an average of at least 0.8 radically-crosslinkable groups will be obtained when (meth)acryloyl group-containing rosins are used.

JP-A-2000-212232 discloses an active energy ray-curable resin composition including a copolymer containing a rosin-containing (meth)acrylate compound as a monomer and a reactive diluent, which forms a coating layer that exhibits no pressure-sensitive adhesion at ordinary temperature and pressure but exerts releasable pseudo-adhesion through compression. However, when the rosin-containing (meth)acrylate compound is used in such a way that it is incorporated in advance into the polymer in this way, the viscosity of the composition rises remarkably and not only handling is difficult, but also workability is poor at the time of coating, so that a large amount of reactive diluent is required for dilution. In addition, it is impossible to apply the coating layer to a base material having weak strength because it is necessary to compress the coating layer for the adhesion. Furthermore, there is no description about the viscoelastic properties of the coating film to be obtained, and those skilled in the art cannot predict what kind of effects on the (meth)acrylic polymer (I) with an average of at least 0.8 radically-crosslinkable groups will be obtained when (meth)acryloyl group-containing rosins are used.

JP-A-6-100641 discloses a photoreactive composition used for producing a transparent laminate containing, as a component, an acrylic monomer and a rosin-containing compound having an unsaturated double bond, and describes that acrylic rubber, epichlorohydrin rubber, isoprene rubber, butyl rubber or the like may be added as a thickener to inject the composition uniformly between the two transparent plates. However, the rubber component added as a thickener is extremely small with respect to the reactive composition, and if the rubber component is added in an amount exceeding the amounts of the acrylic monomer and the rosin-containing compound having an unsaturated double bond, thickening is remarkable, and not only handling is very difficult but also bubbles remain after injection and the composition is not cured even when irradiated with light because the photoreactive group is not introduced into the rubber component. Furthermore, only the effect on adhesiveness is described and there is no description about the viscoelastic properties of the obtained cured product Thus, those skilled in the art cannot predict what kind of effects on the (meth)acrylic polymer (I) with an average of at least 0.8 radically-crosslinkable groups will be obtained when (meth)acryloyl group-containing rosins are used.

JP-A-2008-106212 discloses an adhesive composition containing a thermoplastic resin, a radically polymerizable compound having two or more (meth)acryloyl groups in the molecule, and a specific radically polymerizable monomer, and describes that the adhesive composition is capable of being cured at low temperature in a short time, has sufficiently small connection resistance between electrodes, and can bond members with a sufficient adhesive force. Although various (meth)acrylate oligomers are described as radically polymerizable compounds and rosin epoxy compounds are described as flowability imparting agents, there is no description of (meth)acrylic polymers having radically-crosslinkable groups used in one or more embodiments of the present invention. The patent literature describes that as the effect of adding a rosin and a rosin derivative as a flowability imparting agent, good dispersibility is obtained and flowability are well improved at a comparatively low temperature during heating. However, there is no description about the viscoelastic properties of the obtained cured product, and those skilled in the art cannot predict what kind of effects on the (meth)acrylic polymer (I) with an average of at least 0.8 radically-crosslinkable groups will be obtained when (meth)acryloyl group-containing rosins are used.

Thus, according to the conventionally known technology, it is unknown that a (meth)acrylic polymer having a radically-crosslinkable group and a (meth)acylate compound having a rosin ester group can be used in combination and what kind of effects on the dynamic viscoelastic properties of the obtained cured product will be obtained by the combination. In the case of using a (meth)acrylate compound having a rosin ester group for radical curing, the general purpose has been mainly for improvement in adhesion properties.

However, according to one or more embodiments of the present invention, only when a (meth)acrylic polymer having a radically-crosslinkable group and a (meth)acrylate compound having a rosin ester group are combined, it has been found that the obtained cured product is excellent in dynamic viscoelastic properties and tan δ achieves a high value in a wide temperature range.

<Curable Composition>

In the curable composition of one or more embodiments of the present invention, various compounding agents may be added according to the intended physical properties.

<Tackifying Resin>

For the curable composition of one or more embodiments of the present invention, a tackifying resin may be used if necessary. Examples of the tackifying resin include terpene resins (α-pinene resin, β-pinene resin, limonene resin, dipentene resin, terpene phenol resin, terpene styrene resin, aromatic modified terpene resin, aromatic hydrocarbon modified terpene resin), synthetic petroleum resins (aliphatic, aromatic or alicyclic synthetic petroleum resin etc.), coumarone-indene resins, xylene resins, xylene-phenol resins, phenol resins, styrene-based resins, dicyclopentadiene resins, phenol resins, modified phenol resins (e.g., cashew oil modified phenol resin, tall oil modified phenol resin, etc.), cyclopentadiene-phenol resins, C5 petroleum resins, C9 petroleum resins, petroleum resins obtained by copolymerizing C5 petroleum resin and C9 petroleum resin, rosin resins, rosin ester resins, modified rosin resins, other rosin derivatives (disproportionated rosin, polymerized rosin, rosin esters (esterified rosins with alcohols, glycerol or pentaerythritol)), low molecular weight polystyrene-based resins, styrene copolymer resins, styrene-based block copolymers, petroleum resins (e.g., C5 hydrocarbon resins (aliphatic petroleum resins obtained by polymerizing fractions such as isoprene, 1,3-pentadiene, cyclopentadiene, methylbutene, pentene, etc.), C9 hydrocarbon resin (aromatic petroleum resins obtained by polymerizing fractions such as a-methylstyrene, o-vinyltoluene, m-vinyltoluene, p-vinyltoluene, etc.), C5C9 hydrocarbon copolymer resins, etc.), and products obtained by adding hydrogen to unsaturated double bonds in these compounds, such as hydrogenated terpene resins and hydrogenated rosin ester resins.

Examples of the styrene-based block copolymer and its hydrogenated product include styrene-butadiene-styrene block copolymer (SBS), styrene-isoprene-styrene block copolymer (SIS), styrene-ethylene butylene-styrene block copolymer (SEBS), styrene-ethylene propylene-styrene block copolymer (SEPS), styrene-isobutylene-styrene block copolymer (SIBS), and the like.

Of these, a terpene resin and a rosin resin are preferable because they are easily obtained and are inexpensive. A light color or super light color tackifying resin is preferable from the viewpoint of excellent transparency and not inhibiting curability during radical photopolymerization. Such a tackifying resin is available from Arakawa Chemical Industries Ltd., Yasuhara Chemical Co., Ltd., Harima Chemicals Group, Inc. or the like.

These tackifying resins may be used singly, or two or more kinds thereof may be used in combination.

In the case of adding the tackifying resin, the addition amount thereof is not particularly limited, but is preferably 1 to 100 parts by weight, more preferably 5 to 50 parts by weight, based on 100 parts by weight of the (meth)acrylic polymer (1) with an average of at least 0.8 radically-crosslinkable groups, from the viewpoint of good workability of the radically curable composition and less influence on the curability of the obtained cured product.

### <Reactive Diluent>

In the curable composition of one or more embodiments of the present invention, monomers having a radically polymerizable group can also be used together as a reactive diluent for the purpose of improving the workability by decreasing the viscosity and improving the physical properties of the cured product.

Examples of the radically polymerizable group include a (meth)acryl group, a styrene group, an acrylonitrile group, a vinyl ester group, an N-vinylpyrrolidone group, a conjugated diene group, a vinyl ketone group, a vinyl chloride group, and the like. Among these, a (meth)acryloyl-based group and an acrylamide group similar to the radically-crosslinkable group used in the (meth)acrylic polymer (I) with an average of at least 0.8 radically-crosslinkable groups used in one or more embodiments of the present invention are preferred.

Specific examples of the monomer include a (meth)acrylic monomer, a styrene-based monomer, acrylonitrile, a vinyl ester-based monomer, N-vinylpyrrolidone, a conjugated diene-based monomer, a vinyl ketone-based monomer, a vinyl halide/vinylidene halide-based monomer, a polyfunctional monomer, and the like.

Examples of the (meth)acrylic monomer include (meth)acrylic monomers used for the (meth)acrylic polymer (I) with an average of at least 0.8 radically-crosslinkable groups.

Examples of the styrene-based monomer include styrene, α-methylstyrene and the like.

Examples of the vinyl ester-based monomer include vinyl acetate, vinyl propionate, vinyl butyrate, and the like.

Examples of the conjugated diene-based monomer include butadiene, isoprene, and the like.

Examples of the vinyl ketone-based monomer include methyl vinyl ketone and the like.

Examples of the vinyl halide/vinylidene halide-based monomer include vinyl chloride, vinyl bromide, vinyl iodide, vinylidene chloride, vinylidene bromide, and the like.

Examples of the bifunctional or higher polyfunctional monomer include saturated hydrocarbon diol di(meth)acrylates (e.g., 1,9-nonanediol di(meth)acrylate, 1,10-decanediol di(meth)acrylate, 1,6-hexane di(meth)acrylate, neopentyl glycol di(meth)acrylate, 1,4-butane di(meth)acrylate, 1,3-butane di(meth)acrylate and 1,2-ethylene di(meth)acrylate), bifunctional (meth)acrylate compounds (e.g., neopentyl glycol polyethoxy di(meth)acrylate, neopentyl glycol polypropoxy di(meth)acrylate, polyethylene glycol di(meth)acrylate, polypropylene glycol di(meth)acrylate, polyethylene glycol-polypropylene glycol di(meth)acrylate, polypropylene glycol-polytetramethylene glycol di(meth)acrylate, glycerol di(meth)acrylate, polytetramethylene glycol di(meth)acrylate, dimethylol tricyclodecane di(meth)acrylate, cyclohexanedimethanol di(meth)acrylate, bisphenol A diethoxy di(meth)acrylate, EO-modified bisphenol A di(meth)acrylate, PO-modified bisphenol A di(meth)acrylate, PO-EO modified bisphenol A di(meth)acrylate, tetrabromobisphenol A diethoxy di(meth)acrylate, 4,4-dimercaptodiphenylsulfide di(meth)acrylate, bisphenol F polyethoxy di(meth)acrylate, bisphenol A polyethoxy di(meth)acrylate, 2-(2-(meth)acryloyloxy-1,1-dimethyl)-5-ethyl-5-acryloyloxymethyl-1,3-dioxane, 2-[5-ethyl-5-[(acryloyloxy)methyl]-1,3-dioxan-2-yl]-2,2-dimethylethyl and 1,1-(bis(meth)acryloyloxymethyl) ethyl isocyanate), trifunctional (meth)acrylate compounds (e.g., trimethylolpropane tri(meth)acrylate, trimethylolpropane polyethoxy tri(meth)acrylate, trimethylolpropane polypropoxy tri(meth)acrylate, tetramethylolmethane tri(meth)acrylate, isocyanuric acid tri(meth)acrylate, ethoxylated isocyanuric acid tri(meth)acrylate, pentaerythritol tri(meth)acrylate, and glycerol tri(meth)acrylate), and polyfunctional (meth)acrylate compounds (e.g., dipentaerythritol hexa(meth)acrylate, tris(hydroxyethyl) isocyanurate polyhexanolide tri(meth)acrylate, pentaerythritol tetra(meth)acrylate, tetramethylolmethane tetra(meth)acrylate, and ditrimethylol propane tetra(meth)acrylate).

Examples of the oligomer include epoxy acrylate-based resins such as bisphenol A-type epoxy acylate resin, phenol novolac-type epoxy acrylate resin, cresol novolac-type epoxy acrylate resin, and COOH group-modified epoxy acrylate-based resin; urethane acrylate-based resins obtained by reacting a urethane resin that is obtained from a polyol (e.g., polytetramethylene glycol, ethylene glycol/adipic acid polyester diol, s-caprolactone modified polyester diol, polypropylene glycol, polyethylene glycol, polycarbonate diol, hydrogenated hydroxyl-terminated polyisoprene, hydroxyl-terminated polybutadiene, hydrogenated hydroxyl-terminated polybutadiene, and hydrogenated hydroxyl-terminated polyisobutylene) and an organic isocyanate (e.g., tolylene diisocyanate, isophorone diisocyanate, diphenylmethane diisocyanate, hexamethylene diisocyanate, and xylylene diisocyanate), with a hydroxy-containing (meth)acrylate {e.g., hydroxyethyl (meth)acrylate, hydroxypropyl (meth)acrylate, hydroxybutyl (meth)acrylate, and pentaerythritol triacrylate); resins to which a (meth)acrylic group has been introduced to the polyol via an ester bond (e.g., BAC-15, BAC-45, and SPBDA-S30, manufactured by Osaka Organic Chemical Industry Ltd.); general UV curable or oxygen curable resins such as polyester acrylate-based resins, unsaturated polyester resins, and poly(meth)acrylic acrylate-based resins (poly(meth)acrylic acid ester-based resins having a polymerizable reactive group), so-called macromonomers such as methyl methacrylate resins having a (meth)acryloyl group at one terminal, styrene resins, styrene/acrylonitrile resins, polybutyl acrylate, polyisobutyl methacrylate, methyl methacylate/hydroxyethyl methacrylate copolymer resins, 2-ethylhexyl methacylate/hydroxyethyl methacrylate copolymer resins, and silicone resins, and the like.

In the case of adding the reactive diluent, the addition amount thereof is not particularly limited, but from the viewpoint of good workability of the curable composition and less influence on the curing shrinkage ratio, the amount is preferably 0.1 to 200 parts by weight, more preferably 0.1 to 100 parts by weight based on 100 parts by weight of the (meth)acrylic polymer (I) with an average of at least of 0.8 radically-crosslinkable groups.

<Filler>

A filler can be added to the radically curable composition of one or more embodiments of the present invention in order to impart mechanical strength and abrasion resistance and to adjust the thixotropy of the curable composition. Specifically, various fillers and fine hollow particles described in paragraphs [0134] to [0151] of JP-A-2006-291073 can be mentioned. Examples of the filler include fine powder silica that is reinforcing silica such as fumed silica and wet process silica, carbon black, wood powder, pulp, cotton chips, mica, walnut shell powder, rice husk powder, graphite, clay, silica (crystalline silica, fused silica, dolomite, silicic anhydride, hydrous silicic acid, etc.), calcium bicarbonate, colloidal calcium carbonate magnesium carbonate, diatomaceous earth, calcined clay, clay, talc, titanium oxide, bentonite, organobentonite, ferric oxide, red iron oxide, fine aluminum powder, flint powder, zinc oxide, active zinc white, zinc powder, zinc carbonate, Shirasu balloon, beads of polyacrylic resin/polyacrylonitrile-vinylidene chloride resin/phenol resin/polystyrene resin, and hollow fine particles thereof, inorganic hollow fine particles such as glass balloon/Shirasu balloon and fly ash balloon, fibrous fillers such as glass fibers, glass filaments, carbon fibers. Kevlar fibers and polyethylene fibers, conductive fillers such as carbon nanotubes, fullerenes, conductive carbon, tin, and lithium titanate, thermally conductive fillers such as graphite, boron nitride, aluminum nitride, silicon nitride, alumina, magnesia, beryllia, calcium carbonate, aluminum powder, copper powder, iron powder, titanium carbide, and diamond, sound absorption fillers, and the like.

Among them, fumed silica, wet process silica, carbon black, and calcium carbonate are preferable from the viewpoint of excellent reinforcing properties.

In fumed silica and wet process silica that are used as a reinforcing silica, those having a particle diameter of 50 μm or less and a specific surface area of 80 m²/g or more are preferable from the viewpoint of reinforcing effect. Further, surface-untreated silica is more superior to surface-treated silica that is treated with organosilane, organosilazane, diorganocyclopolysiloxane or the like, in terms of easiness of kneading, good flowability of the composition, and excellent economic efficiency. More specific examples of the reinforcing silica include, but are not limited to, AEROSIL manufactured by Nippon Aerosil Co., Ltd., which is one of fumed silicas, and Nipsil manufactured by Nippon Silica Industry Co., Ltd. which is one of wet process silicas, and the like.

The above specific surface area value is a measurement value by the BET method (physical adsorption of inert gas at low temperature and low humidity).

As the carbon black, any carbon black such as channel black, furnace black, acetylene black, and thermal black is preferably used, and furnace black is more preferable from the viewpoint of good reinforcement and excellent economic efficiency.

An addition amount of the filler is not particularly limited, but is preferably 0.1 to 100 parts by weight; preferably 0.5 to 80 parts by weight, particularly preferably 1 to 50 parts by weight, based on 100 parts by weight of the (meth)acrylic polymer (1) with an average of at least 0.8 radically-crosslinkable groups. When the compounding amount is less than 0.1 parts by weight, the effect of improving the reinforcing property may be insufficient in some cases, and when the compounding amount exceeds 100 parts by weight, the workability of the curable composition may be lowered. In addition, the fillers may be used singly or in combination of two or more kinds thereof.

<Plasticizer>

A plasticizer can be added to the radically curable composition of one or more embodiments of the present invention. By adding a plasticizer, mechanical properties such as the viscosity of the radically curable composition and the tensile strength and elongation of the obtained cured product can be adjusted, and the transparency of the cured product can be improved. Examples of the plasticizer include, but are not particularly limited to, the followings in accordance with purposes such as the adjustment of the physical properties or characteristics: phthalic acid esters such as dibutyl phthalate, diheptyl phthalate, di(2-ethylhexyl) phthalate, and butylbenzyl phthalate; non-aromatic dibasic acid esters such as dioctyl adipate, dioctyl sebacate, dibutyl sebacate, and isodecyl succinate; aliphatic esters such as butyl oleate and methyl acetylricinoleate; esters of polyalkylene glycols such as diethylene glycol dibenzoate, triethylene glycol dibenzoate, and pentaerythritol ester, phosphates such as tricresyl phosphate and tributyl phosphate; trimellitic acid esters; pyromellitic acid esters; polystyrenes such as polystyrene and poly-α-methylstyrene; polybutadiene, polybutene, polyisobutylene, butadiene-acrylonitrile, and polychloroprene; chlorinated paraffins; hydrocarbon oils such as alkyldiphenyl and partially hydrogenated terphenyl; process oils; polyethers such as polyether polyols including polyethylene glycol, polypropylene glycol, and polytetramethylene glycol, and derivatives obtained by converting the hydroxyl group of the polyether polyols into ester group, ether groups or the like; epoxy plasticizers such as epoxidized soybean oil and benzyl epoxystearate; polyester-based plasticizers obtained from dibasic acids such as sebacic acid, adipic acid, azelaic acid and phthalic acid, and dihydric alcohols such as ethylene glycol, diethylene glycol, triethylene glycol, propylene glycol and dipropylene glycol; and (meth)acrylic polymers obtained by polymerizing a vinyl-based monomer including an acrylic plasticizer such as ARUFON series manufactured by Toagosei Co., Ltd. by various methods. These may be used singly, or two or more kinds thereof may be used in combination.

In the case of adding the plasticizer, the addition amount thereof is not particularly limited, but from the viewpoint of good workability of the radically curable composition and less influence on the mechanical properties of the obtained cured product, the amount is preferably 1 to 100 parts by weight, more preferably 1 to 50 parts by weight, based on 100 parts by weight of the (meth)acrylic polymer (I) with an average of at least 0.8 radically-crosslinkable groups.

<Solvent>

If necessary, a solvent can be blended with the curable composition used in one or more embodiments of the present invention.

Examples of the solvent that can be blended include aromatic hydrocarbon-based solvents such as toluene and xylene; ester-based solvents such as ethyl acetate, butyl acetate, amyl acetate, and cellosolve acetate; ketone-based solvents such as acetone, methyl ethyl ketone, methyl isobutyl ketone, and diisobutyl ketone, alcohol-based solvents such as methanol, ethanol and isopropanol; and hydrocarbon-based solvents such as hexane, cyclohexane, methylcyclohexane, heptane, and octane. These may be used singly, or two or more kinds thereof may be used in combination.

In the case of adding the solvent, the addition amount thereof is not particularly limited, but is preferably 50 parts by weight or less, more preferably 30 parts by weight or less, based on 100 parts by weight of the (meth)acrylic polymer (1) with an average of at least 0.8 radically-crosslinkable groups, from the viewpoint of good workability of the curable composition and less influence on the curing shrinkage, and still more preferably 10 parts by weight or less from the viewpoint of less influence on the working environment.

<Thixotropic Agent (Anti-Sagging Agent)>

A thixotropy imparting agent (anti-sagging agent) may be added to the curable composition of one or more embodiments of the present invention for preventing sagging and improving workability as necessary.

The thixotropy imparting agent is not particularly limited, but examples thereof include hydrogenated castor oil derivatives, metal soaps having a long chain alkyl group, ester compounds having along chain alkyl group, inorganic fillers such as silica, amide wax, and the like. These thixotropic agents may be used singly, or two or more kinds thereof may be used in combination.

In the case of adding the thixotropic agent, the addition amount thereof is not particularly limited, but from the viewpoint of good workability of the curable composition, the amount is preferably 0.1 to 10 parts by weight, more preferably 0.1 to 5 parts by weight, based on 100 parts by weight of the acrylic polymer (I) with an average of at least 0.8 radically-crosslinkable groups.

<Antioxidant>

For the curable composition of one or more embodiments of the present invention, an antioxidant (an aging preventing agent) can be used. When an antioxidant is used, the heat resistance of the cured product can be enhanced. Examples of the antioxidant include primary antioxidants such as a general hindered phenol-based antioxidant an amine-based antioxidant, a lactone-based antioxidant and an ethanolamine-based antioxidant and secondary antioxidants such as a sulfur-based antioxidant and a phosphorus-based antioxidant. As the antioxidant, those described in paragraphs [0232] to [0235] of JP-A-2007-308692 and paragraphs [0089] to [0093] of WO 05/116134 A can be used.

In the case of adding the antioxidant, the addition amount thereof is not particularly limited, but from the viewpoint of sufficient exhibition of the effect on heat resistance and economic advantages, the addition amount is preferably 0.1 to 5 parts by weight, more preferably 0.1 to 3 parts by weight based on 100 parts by weight of the (meth)acrylic polymer (I) with an average of at least 0.8 radically-crosslinkable groups.

<Other Additives>

Various additives may be added to the curable composition of one or more embodiments of the present invention, if necessary, for the purpose of adjusting various physical properties of the curable composition or the cured product Examples of such additives include compatibilizers, curability modifiers, radical inhibitors, metal deactivators, ozone deterioration inhibitors, phosphorus peroxide decomposers, lubricants, pigments, antifoaming agents, foaming agents, termiticides, fungicides, ultraviolet absorbers, light stabilizes, and the like. Specific examples other than the specific examples of the additives mentioned in one or more embodiments of the present specification can be found in JP-B-4-69659, JP-B-7-108928, JP-A-63-254149, JP-A-64-22904, JP-A-2001-72854, and the like.

<Preparation of Radically Curable Composition>

The radically curable composition of one or more embodiments of the present invention can be prepared as a one-component photocuring type in which all of the blending components are preliminarily blended and then cured by UV or electron beam irradiation after application, a one-component heat curing type that is cured by heat after application, or a two-component mixed type in which the blending components are previously divided into two liquids and then are mixed to generate radicals.

A method for preparing the curable composition of one or more embodiments of the present invention is not particularly limited. For example, the following general methods can be adopted. i.e. the components may be blended and mixed with a hand mixer or a static mixer or kneaded at normal temperature or under heating with a planetary mixer, a disper, a roll, a kneader etc., or dissolved by using a small amount of a suitable solvent and then mixed. In particular, when a filler is mixed, it is preferable to use a planetary mixer, a disper, a roll, a kneader or the like.

<Curing Method>

The curable composition of one or more embodiments of the present invention is not particularly limited, but is preferably cured by active energy rays such as UV and electron beam or by heat.

<Active Energy Ray Curing>

In the active energy ray irradiation of one or more embodiments of the present invention, a light source used for ordinary active energy ray curing can be used, and examples thereof include solar rays, low pressure mercury lamps (sterilizing lamps, fluorescent chemical lamps, black light), cold cathode fluorescent tubes (CCFL), fluorescent lamps, incandescent bulbs, medium pressure mercury lamps, high pressure mercury lamps, ultra-high-pressure mercury lamps, carbon arc lamps, metal halide lamps, gallium lamps, tungsten lamps, xenon lamps, mercury xenon lamps, chemical lamps, electrodeless discharge lamps, zirconium lamps, field emission lamps, ultraviolet excimer fluorescent lamps, organic EL, LED, UV-LED, and the like. Among them, a high-pressure mercury lamp, a metal halide lamp, an electrodeless discharge lamp, a cold cathode fluorescent tube (CCFL), and a UV-LED are preferable from the viewpoint of easy handling and economic efficiency.

Further, the wavelength, irradiation intensity, and accumulated light amount of active energy rays are appropriately adjusted depending on the kind and amount of the radically-crosslinkable group, the kind and amount of the radical photoinitiator, and the shapes such as thickness and size of the desired cured product.

Examples of the method of irradiating active energy rays include a method of continuously irradiating active energy rays on a belt conveyor, a method of stopping a belt conveyor only when irradiating active energy rays and then irradiating the active energy rays uniformly, and a method (batch type) in which a curable composition is introduced into/taken out from active energy ray irradiation apparatus for each irradiation. The belt conveyor method is suitable for continuous curing. In the batch type method, there is no need for a large-scale apparatus such as a belt conveyor, and there is an advantage that it is easy to uniformly irradiate an object with active energy rays. In the belt conveyor method, for example, the curable composition is placed on a belt conveyor and irradiated with active energy rays from an active energy ray irradiation apparatus fixed above or side or below the conveyor.

Alternatively, the curable composition can be applied and cured according to coating robot movement irradiation robot movement, or stage movement by using a spot type active energy ray irradiation apparatus.

In the case of active energy ray curing, it is known that surface curing inhibition is liable to be caused by the influence of oxygen in the air. In order to avoid this, for example, a radically curable composition may be covered with a transparent barrier film such as a PP film, a PET film, or a Teflon (registered trademark) film so that the surface does not come into contact with oxygen, and then active energy ultraviolet rays may be irradiated through the film. Alternatively, active energy rays may be irradiated in an inert zone in which oxygen is substituted with an inert gas such as nitrogen gas or carbon dioxide gas. In the latter method, in order to improve the reaction rate of the radically curable composition, the oxygen concentration in the irradiation atmosphere is preferably 5000 ppm or less, more preferably 500 ppm or less.

However, it is obvious that the curing method of one or more embodiments of the present invention is not limited to the above method.

<Thermosetting>

In the case of curing by heat, the temperature is preferably in the range of 50PC to 250° C., more preferably in the range of 70° C. to 200° C., though the temperature may vary depending on the kinds of the thermal radical initiator to be used, the (meth)acrylic polymer (I) with an average of at least 0.8 radically-crosslinkable groups, and the compound to be added. The curing time varies depending on the thermal radical initiator, monomer, solvent, reaction temperature, etc. to be used, but is usually within the range of 0.5 minutes to 10 hours. In the case of thermosetting to obtain a molded article, there is no particular limitation, and various commonly used molding methods can be used. For example, cast molding, compression molding, transfer molding, injection molding, extrusion molding, rotational molding, hollow molding, thermoforming and the like can be mentioned. In particular, from the viewpoint that automatic and continuous production is possible, and productivity is excellent, injection molding or compression molding is preferable.

<Characteristics of Cured Product>

The cured product of one or more embodiments of the present invention is not particularly limited, but the cured product exhibiting rubber elasticity is particularly preferable. The term “rubber elasticity” means characteristics such that when the obtained cured product is touched, it is soft has excellent elongation, and easily returns to its original shape even if the cured product is stretched or bent.

<Regarding Use Method of Cured Product>

The cured product of one or more embodiments of the present invention may be used singly or in combination with other members, if necessary. The radically curable composition may be poured into some type of mold, solidified, and then taken out from the mold, or cured using a desired mold and used together with each mold. Alternatively, the radically curable composition may be applied in a dotted, beaded, planar or arbitrary shape by a roller, a dispenser or the like. The obtained cured product may be bonded to other members such as film, rubber, plastics, metal, ceramics, paper, nonwoven fabric, etc., fitted thereto, or sandwiched therebetween, or integrated therewith via an adhesive or a pressure-sensitive adhesive. Alternatively, after bringing a radically-curable composition into contact with another member by a method such as coating or injection, the composition may be cured by irradiation with active energy rays or heating to obtain a composite molded article.

However, it is obvious that the cured product of one or more embodiments of the present invention is not limited to the use method described above.

<Applications>

Applications of the radically curable composition and cured product according to one or more embodiments of the present invention are not limited, but examples thereof include various applications for sports goods, toys/playground equipment, stationery, medicine/medical care/nursing care products, footwear, bedding/sleeping products, furniture, clothing, various miscellaneous goods, transportation goods, OA equipment, home appliances, audio equipment, portable equipment, industrial machinery/equipment, precision equipment, electric/electronic equipment, electric/electronic parts, and building materials such as sealing materials, coating materials, adhesives, pressure-sensitive adhesives, molded articles, sealants, molded parts, paints, inks, foams, resist materials, field molded gaskets, impact absorbing materials, impact cushioning materials, pressure dispersing materials, vibration damping materials, vibration-proofing materials, acoustic materials, acoustic insulators, heat insulating materials, feel improving members.

When used for various applications, the radically curable composition and cured product according to one or more embodiments of the present invention can also be used as shock absorbers, insulators, bushes, various mounts, rollers, films, sheets, tapes, seals, chips, molding members.

The radically curable composition and cured product according to one or more embodiments of the present invention are useful for sports applications including molded article applications, sealing material applications, sealant applications, impact absorbing applications, impact cushioning applications, pressure dispersion applications, vibration damping applications, vibration proofing applications, sound absorbing applications, soundproofing applications, applications for improving the feel of contact with the human body, for impact cushioning materials to be installed on the fence, floor etc. of ball stadium, stadium, or gymnasium; landing mats for gynmastics competition or exercise; floor exercise mats; stretch mats in a gym; kids mats; bouldering mats (crash pad); beat boards; cushioning materials for high diving; wet suits; grips and heartwood for golf clubs, bats, and tennis rackets etc.; heartwood of gloves and mitts; sports shoe overlays, insoles, inner soles; ski boots liners, snowboard boots liners; toe shoes; ballet shoes; golf club heads; golf balls and baseball balls and other balls for ball games; sports protectors (for example, headgear used in fighting sports (e.g., rugby and boxing), helmets for baseball and football; elbow pads for baseball, football, fighting sports, etc.; leggas (shin guards), etc.); rackets; balls; rider suits; gloves (for soccer keeper gloves, golf, ski and rider); rifle jackets (for example shoulder pads), and the like.

The radically curable composition and cured product according to one or more embodiments of the present invention are useful for toy/playground applications including molded article applications, sealing materials applications; sealant applications; impact absorbing applications; impact cushioning applications; pressure dispersion applications; vibration damping applications; vibration-proofing applications; sound absorbing applications; soundproofing applications; applications for improving the feel of contact with the human body, and the like, for seals, hand exerciser, healing goods, key holders, cushioning materials and stuffing such as stuffed toys, moving stuffed toys, mannequin body, balls, and massage balls, game controllers and mats, decorative articles for mobile phones and smart phones, materials used for other decorative articles, animal models, molded articles such as monsters and dolls, figures, and the like.

The radically curable composition and cured product according to one or more embodiments of the present invention can be used for medical and nursing applications including artificial skin, artificial bone, artificial cartilage, artificial organ, artificial cornea artificial lens, artificial vitreous body, artificial muscle, artificial blood vessel, artificial joint, human body model, chest pad and insert material for bathing suits and large breasts, materials used for other biocompatible materials, chemical solution exudation pad, hemostatic pad, gas/liquid separation filter (indwelling needle filter), patch agent, medical liquid absorption tool, mask, compression pad, surgical disposable product, medical tubes/caps/bag/gaskets/hoses, beds/treatment table/chair for medical treatment, electrode material for electrocardiogram measurement electrode pads for low frequency treatment equipment, sensor pads, bed sores prevention mattresses, posture transformation cushions, cushions for wheelchairs, wheelchair seating surface, nursing care products such as shower chair, bathing nursing pillow, taping, gyps liner, soft contact lens materials, prosthetic hand/prosthetic leg, cushioning materials (liner etc.) for connecting prosthetic hand/prosthetic leg to the human body, joint parts of prosthetic hand and prosthetic leg, dental rests, other dental supplies, shock absorbing pads, hip protectors, protectors for elbow/knee, post-surgical body shape supplements, poultice materials, wound dressings, cell culture sheets, adult models for therapeutic training, and the like. In addition, as an article to be used in contact with a human body, the radically curable composition and cured product according to one or more embodiments of the present invention is useful for applications including, for example, pain relief for corn and calluses, supporters, pumps and other rubbing prevention materials, drying prevention pads for elbow or heel, impact absorption for foot care to alleviate pain due to hallux valgus and incurvated nail etc. Furthermore, the radically curable composition and cured product according to one or more embodiments of the present invention can be used for percutaneous absorption preparations and pressure sensitive adhesives for adhesion, medical drugs/medical sealing materials, medical pressure-sensitive adhesives, medical rubber stoppers, impression materials, dental filling materials, syringe gaskets, rubber stopper for reduced pressure vessel, O rings or flat gaskets for artificial dialysis equipment, packaging materials for pharmaceuticals/medical instruments, caps, cap liners, caps for vacuum blood collection tubes, sealants and adhesives for catheters, sealants and adhesives for implantable medical devices and attached sensors, and the like.

The radically curable composition and cured product according to one or more embodiments of the present invention can be used in footwear applications for men's shoes, ladies' shoes, children's shoes, shoes for the elderly, sports shoes, safety shoes, etc., and are useful for molded article applications, impact cushioning applications, impact absorbing applications, comfort improvement applications, and beauty and slimming applications, for each shoe skin material, lining, insole (inner sole), shoe sole (outsole, midsole, heel), cushioning material, shoe sore-preventing pad, various shoe pads, inner boot, slipper, slipper core, sandal, sandal insole, etc.

The radically curable composition and cured product according to one or more embodiments of the present invention can be used in bedding/sleeping applications including bedsores prevention applications, body pressure distribution applications, sleeping comfort improvement applications, impact absorbing applications, and molded article applications, of pillows, comforters, bottom mattresses, bedding, bedding for hairdressing/beauty, mattresses, bed mats, bed pads, cushions, baby cribs, baby neck pillows, etc.

The radically curable composition and cured product according to one or more embodiments of the present invention can be used in furniture applications including body-pressure distribution applications, comfort improvement applications, impact absorbing applications, feel improvement applications, etc. for chairs, seat chairs, cushions, sofas, sofa cushions/seat cushions, various cushions such as lumbar cushions, carpets/mats, foot warmer sheets/comforters, or toilet seat mats. The radically curable composition and cured product according to one or more embodiments of the present invention also can be used in feel improvement applications, impact absorbing applications, soundproof applications, and molded article applications, for desks, closets, clothes cases, bookshelves, stairs, doors, doors, sliding door, screens, sliding door handles, handrails, door stop, and the like.

The radically curable composition and cured product according to one or more embodiments of the present invention can be used in clothing applications including impact absorbing applications, heat insulation applications, molded article applications, and the like, such as for pad materials (e.g., shoulder/brassiere pads), cold-proof clothes, helmets, and bulletproof vests.

The radically curable composition and cured product according to one or more embodiments of the present invention can be used in various miscellaneous goods applications including molded article applications, seal material applications, impact absorbing applications, cushioning applications, vibration damping applications, vibration proofing applications, sound absorbing applications, soundproofing applications, applications for improving the feel of contact with the human body, and the like, such as for bath products such as bath pillows, puffs for massage, mouse pads, arm rests and wrist rests for personal computers, anti-slip cushions, stationery (e.g., pen grips, penetrating stamping materials), small pillows for desks, earplugs, cotton swabs, hot pack sheets, cold pack sheets, poultices, eyeglass pads, underwater glasses pads, face protectors, wristwatch pads, headphone ear pads, earphones, heat keeping cups, beverage cans, ice pillow covers, folding pillows, writing instruments, bags (e.g., shoulder straps or handbag part of school bags, etc.), grips for daily miscellaneous goods/carpenters, members for carpet, materials for rugs such as artificial grass members, elbow pads, knee pads, gloves, pseudo baits for fishing, and saddle slippage prevention materials in horseback by saddle.

The radically curable composition and cured product according to one or more embodiments of the present invention can be used in transport applications including molded article applications, seal material applications, vibration damping applications, vibration proofing applications, impact absorbing applications, sound absorbing applications, soundproofing applications, cushioning applications, applications for improving the feel of contact with the human body, and the like, such as for seats for cars, motorcycles, bicycles, electric bicycles, tricycles, strollers, construction machinery, railway vehicles, ships, aircraft, etc., child seats, headrests, armrests, footrests, headliners, saddles, rider cushions, helmets, bed mats for custom car, cushions for camper interior materials such as ceiling materials, door trims, floor cushion instrument panels, custom dashboards, door panels, inner panels, shift knobs, handles, grips, pillars, console boxes, airbag covers, parking brake covers, quarter trims, lining, center pillar garnish, sun visor, etc., recording/reproducing device and various sensors in vehicle-mounted road navigation system, in-vehicle electronic devices such as control devices, engine periphery such as harness, dust cover, hose, engine, battery, oil pan, front cover, and locker cover, vehicle body periphery such as tire, bumper, floor, underfloor, door, roof, panel, wheel house, transmission, weather strip, various auxiliary machinery covers, window packing, roof, panel, wheelhouse, transmission, weather strip, various auxiliary machinery cover, window packing, roof molding, under door molding, seat back, trunk room, vehicle cargo, etc. In addition, such transport applications also include vibration proofing applications, vibration damping applications, impact absorbing applications, and vibration absorbing applications of person-load carrying devices such as carry bags, carriages, containers, flexible containers, and pallets. Examples of articles to be transported include art objects, precision instruments, fruits, fresh fish, eggs, ceramics and porcelains, and the radically curable composition and cured product according to one or more embodiments of the present invention can also be used in transportation of these articles direct packaging or indirectly packaging or these articles which have been packed. Further, the radically curable composition and cured product according to one or more embodiments of the present invention can also be used as molding materials such as shock absorbers, insulators, bushes, various mounts, film sheets, tapes, seals, chips, molded parts for conveyance, transportation, and carriage, and furthermore, they can be used as a vibration damping rubber for automobile vibration proofing rubber, railway vehicle vibration proofing rubber, aircraft vibration proofing rubber, fender etc.

In automotive applications, as a body part, the radically curable composition and cured product according to one or more embodiments of the present invention can be used as a sealing material for maintaining airtightness, an anti-vibration material for glass, a car body section vibration-proofing material, and especially as a window seal gasket and a door glass gasket. As a chassis part, the radically curable composition and cured product according to one or more embodiments of the present invention can be used as engine or suspension rubber for vibration proofing and sound proofing, and especially as an engine-mounted rubber. As an engine part, the radically curable composition and cured product according to one or more embodiments of the present invention can be used for a hose for cooling, fuel supply, exhaust control and the like, a gasket for an engine cover or an oil pan, an engine oil sealing material and the like. Also, they can be used as exhaust gas cleaning equipment parts and brake parts. Further, as a tire part, the radically curable composition and cured product according to one or more embodiments of the present invention can be used as a bead portion, a sidewall portion, a shoulder portion, and a tread portion, or as a sealing material for an inner liner resin or an air-pressure sensor or puncture sensor. In addition, the radically curable composition and cured product according to one or more embodiments of the present invention can be used as a sealing material, a sealant, a gasket, a coating material, a molding member, an adhesive, and a pressure-sensitive adhesive for various electronic components and control components. Still further, the radically curable composition and cured product according to one or more embodiments of the present invention can be used as a covering material for a wire harness made from copper or aluminum, or as a sealing material for a connector part. Additionally, the radically-curable composition and the cured product according to one or more embodiments of the present invention can also be used as a sealing material, an adhesive, a pressure-sensitive adhesive, molded part such as a gasket, an O-ring, a packing and a belt, and the like, for a lamp, a battery, a windshield washer fluid unit, an air conditioning unit, a coolant unit, a brake oil unit, an electrical part, various interior and exterior parts, an oil filter and the like, as well as a potting material for an igniter HIC or an automotive hybrid IC.

The radically curable composition and cured product according to one or more embodiments of the present invention are useful for various equipment applications including molded article applications, seal material applications, sealant applications, vibration damping applications, vibration proofing applications, impact absorbing applications, impact cushioning applications, sound absorbing applications, soundproofing applications, applications for improving the feel of contact with the human body, such as for OA equipment (display, personal computer, telephone, copier, printer, copying machine, game machine, TV various recorders such as DVD recorder, Blu-ray recorder, and HDD recorder, various players such as DVD player and Blu-ray player, projector, digital camera, home video, antenna, speaker, electronic dictionary, IC recorder, fax machine, copy machine, telephone, stepping motor, magnetic disk, hard disk, etc.), as well as useful as adhesives, pressure-sensitive adhesives, packings, O-rings, and belts.

The radically curable composition and cured product according to one or more embodiments of the present invention are useful for vibration damping applications, vibration proofing applications, impact absorbing applications, impact cushioning applications, sound absorbing applications, soundproofing applications, and applications for improving the feel of contact portion (handles, grips, doors, doors and handrails) with the human body, for household appliances (refrigerator, washing machine, washing/drying machine, futon dryer, vacuum cleaner, air purifier, water purifier, electric toothbrush, light fixture, air conditioner, air conditioner outdoor machine, dehumidifier, humidifier, fan heater, fan, ventilator, dryer, massager, blower, sewing machine, dishwasher, dishwasher, door intercom phone, rice cooker, microwave, oven range, IH cooking heater, hot plate, various chargers, irons), as well as useful as a sealing material, adhesive, pressure-sensitive adhesive, packing, O-ring, or belt therefor.

The radically curable composition and cured product according to one or more embodiments of the present invention are useful for vibration proofing applications, vibration damping applications, impact absorbing applications, and impact cushioning applications, in audio equipment (speaker, turntable, optical pickup device, optical recording/reproducing device, magnetic pickup device, magnetic recording/reproducing device, insulator, spacer, etc.).

The radically curable composition and cured product according to one or more embodiments of the present invention are useful for vibration damping applications, vibration proofing applications, impact cushioning applications, applications for improving the feel of contact portion with the human body, in portable devices such as notebook computers, portable hard disks, mobile phones, smart phones, portable music information devices, portable game machines and the like.

In electrical and electronic applications, for example, the radically curable composition and cured product according to one or more embodiments of the present invention can be used for an LED material, various battery peripheral materials, a sensor, a semiconductor peripheral material, a circuit board peripheral material, a display peripheral material for liquid crystals and the like, a lighting material, an optical communication/optical circuit peripheral material, an optical recording peripheral material, a magnetic recording material and the like.

For an LED material, the radically curable composition and cured product according to one or more embodiments of the present invention can be used as a molding material, a sealant, a sealing film, a die-bonding material, a coating material, a sealing material, an adhesive, a pressure-sensitive adhesive, a lens material and the like for an LED element, as well as a sealing material, an adhesive, a pressure-sensitive adhesive, a coating material and the like for an LED bulb, an LED indicator, an LED display board, an LED display device and the like.

For a battery peripheral material, the radically curable composition and cured product according to one or more embodiments of the present invention can be used as a sealing material, a rear face sealant, a molding material for various elements, an adhesive, a pressure-sensitive adhesive, a sealant, a sealing film a coating material, a potting material, a filler, a separator, a catalyst fixing film, a protective film, an electrode binding agent, a sealing material for refrigerant oil, a hose material and the like for a lithium-ion battery, a sodium-sulfur battery, a sodium molten-salt battery, an organic radical battery, a nickel hydrogen battery, a nickel cadmium battery, a redox flow battery, a lithium sulfur battery, an air battery, an electrolytic capacitor, an electric double layer capacitor, a lithium ion capacitor, a fuel cell, a solar cell, a dye-sensitized solar cell and the like.

For a sensor, the radically curable composition and cured product according to one or more embodiments of the present invention can be used as a sealant, a sealing film, a vibration absorbing material, a vibration suppressing material, a lens material, an adhesive, a pressure-sensitive adhesive, a coating agent, a film and the like for various kinds of sensor, such as a sensor for power, load, impact, pressure, rotation, vibration, contact, flow rate, solar radiation, light, smell, time, temperature, humidity, wind speed, distance, position, inertia, slope, velocity, acceleration, angular velocity, hardness, strain, sound, magnetism, current, voltage, power, electron, radiation, infrared ray, X-ray, UV-ray, fluid volume, weight, gas volume, ion content, metal content, color and the like.

For a circuit board peripheral material, the radically curable composition and cured product according to one or more embodiments of the present invention can be used as a sealing material, a coating material, a conformal coating material, a potting material, a molding material for each of the above-described elements, an underfill material, a die-bonding material, a die bonding film, an adhesive, a pressure-sensitive adhesive, a sealant, a sealing film and the like for a rigid or a flexible wiring board or MEMS (micro-electro-mechanical system) on which various elements such as an IC, an LSI, a semiconductor chip, a transistor, a diode, a thyristor, a capacitor, a resistor, a coil and the like are mounted.

For a display peripheral material, the radically curable composition and cured product according to one or more embodiments of the present invention can be used as a molding material for various elements, various filters, films such as a protective film, an antireflection film, a viewing angle compensation film, a polarizer protective film and an optical compensation film, a sealing material, an adhesive, a pressure-sensitive adhesive, a sealant, a sealing film, a coating material for a substrate or a member, a potting agent, a filler, a visibility improver, a lens material, a light guide plate, a prism sheet, a polarizing plate, a retardation plate, and a liquid crystal dam material for a liquid crystal display, a plasma display, a LED display device, an organic EL (electroluminescence) display, a field emission display, electronic paper, a flexible display, a 3D hologram, an organic thin film transistor display, and a head-mounted display and the like.

For a lighting material, the radically curable composition and cured product according to one or more embodiments of the present invention can be used as a sealing material, a coating material, an adhesive, a sealant, and a molded part for an LED for lighting, an organic EL for lighting, and an inorganic EL for lighting.

For an optical communication/optical circuit peripheral material, the radically curable composition and cured product according to one or more embodiments of the present invention can be used as a molding material for various elements, a sealing material, an adhesive, a pressure-sensitive adhesive, a sealant, a sealing film, a coating material, a potting agent, a filler, a protective film, a lens material, a light guide plate, a prism sheet, a polarizing plate, a ferrule and the like for an organic photorefractive element, an optical fiber, an optical switch, a lens, an optical waveguide, a light emitting element, a photodiode, an optical amplifier, an optoelectronic integrated circuit an optical connector, an optical coupler, an optical processing element, a photoelectric converter, a laser element and the like.

For an optical recording material, the radically curable composition and cured product according to one or more embodiments of the present invention can be used as a protective film, a sealing material, an adhesive, a pressure-sensitive adhesive, a sealant, a sealing film, a coating material, a vibration proofing material, and a vibration damping material for a VD (video disc), a CD, a CD-ROM, a CD-R, a CD-RW, a DVD, a DVD-ROM, a DVD-R, a DVD-RW, a BD, a BD-ROM, a BD-R, a BD-RE, an MO, an MD, a PD (phase change disc), a hologram, a disc substrate material for an optical card, a pickup lens and the like.

For a magnetic recording material, the radically curable composition and cured product according to one or more embodiments of the present invention can be used as a vibration-proofing material, a vibration damping material, a sealing material, an adhesive, a pressure-sensitive adhesive, a sealant, a coating material, a cover gasket, and a card material for a hard disk, a magnetic tape, and a magnetic card such as a credit card.

For information electrical devices, the radically curable composition and cured product according to one or more embodiments of the present invention can be used as a sealing material, a sealant, an adhesive, a pressure-sensitive adhesive, a packing, an O-ring, a belt, a vibration proofing material, a vibration damping material, a sound-proofing material and the like for a mobile phone, a media player, a tablet terminal, a smartphone, a portable game machine, a computer, a printer a scanner, a projector, an inkjet tank and the like.

In addition, the radically curable composition and cured product according to one or more embodiments of the present invention can also be used as a touch panel dirt-resistant film, a lubricating film, an IC chip molding material, a Peltier element molding material, an electrolytic capacitor sealing body, a cable joint potting material, a potting material for an IGBT (a vehicle propulsion control device), a semiconductor wafer processing dicing tape, a die-bonding agent, a die-bonding film, an underfill, an anisotropic conductive adhesive, an anisotropic conductive film, a conductive adhesive, a conductive paste, a thermally conductive adhesive, a thermally conductive paste, a temporary fixing film, a fixing film, a sealing film and the like.

For other industrial machinery, electric and electronic equipment and parts thereof, the radically curable composition and cured product according to one or more embodiments of the present invention are useful in vibration proofing applications, vibration damping applications, impact cushioning applications, impact absorbing applications, applications for improving the feel of contact portion with the human body, for micro electro mechanical components called MEMS and various sensors, control devices and batteries, peripheral parts of batteries, LED materials, semiconductor peripheral materials, circuit board peripheral materials, display peripheral materials such as liquid crystals etc., lighting materials, optical communication/optical circuit peripheral materials, optical recording peripheral materials, magnetic recording materials, electron microscopes and other science and engineering instruments, various measuring devices, vending machines. TV cameras, resistors, cabinets, robotic skin shooter, elevators, escalators, moving walkway, conveyors, lifts, tractors, bulldozers, generators, compressors, containers, hoppers, conveyors for fruit-sorting machine, automatic teller machines (ATM), currency exchange machines, counters, vending machines, cash dispensers (CD), secondary batteries such as lithium battery etc., semiconductor manufacturing equipment such as IC tray and conveyor, machines with violent motor vibration such as vibration damping steel plate, rock drilling machine, cutting machine, chain saw, hand mixer, mowing machine etc.

In the field of home electronics, the radically curable composition and cured product according to one or more embodiments of the present invention can be used for packings, O rings, belts and so on. Specific examples of the home electronics include decorations for lighting fixtures, waterproof packings, antivibration rubbers, insecticidal packings, vibration damping/sound absorbing materials and air sealing materials for cleaners, drip-proof covers for electric water heaters, waterproof packings, heater part packings, electrode part packings, safety valve diaphragms, hoses for sake bottle, waterproof packings for steam oven range and jar rice cooker, water supply tank packings, water absorption valves, water receiving packings, connecting hoses, belts, heat retaining heater section packings, oil packings for combustion equipment such as steam outlet seals, O rings, drain packings, pressure tubes, blowing tubes, feeding/intake packings, vibration damping rubbers, oil supply port packings, oil gauge packings, oil delivery pipes, diaphragm valves, air supply pipes, speaker gaskets for acoustic equipment, speaker edges, turntable seats, belts, pulleys, and the like.

For building materials applications, the radically curable composition and cured product according to one or more embodiments of the present invention are useful in vibration damping applications, vibration proofing applications, impact cushioning applications, impact absorbing applications, sound absorbing applications, soundproofing applications, cushioning applications, and soundproof damping applications corresponding to low frequency sound and high frequency sound near the audible range threshold, such as in soundproof panels, soundproof glasses, general glass, ceiling materials, interior wall materials, external wall materials, floor materials, piping materials, water supply members, fences, air film structural roofing materials, structural gaskets (zipper gaskets), seismic isolation rubbers, vibration isolation rubbers, sheets, waterproof sheets, irregular gaskets, regular gaskets, waterproof materials, sealants, packings, grommets, packaging transport materials, residential vibration damping sheets, vibration damping materials, vibration damping materials for bridges, sound insulation materials, setting blocks, sliding materials, glass sealing material for laminated glass and double-glazed glass, anti-rust and waterproof sealing materials on end face (cut part) of netted glass and laminated glass, shutters, curtain rails, curtain walls, vibration isolators, and ground improvement materials.

In the field of ocean and civil engineering, the radically curable composition and cured product according to one or more embodiments of the present invention can be used as structural materials such as rubber expansion joints, bearings, water stop plates, waterproof sheets, rubber dams, elastic pavements, antivibration pads, protective bodies, etc.; as construction secondary materials, such as rubber formworks, rubber packers, rubber skirts, sponge mats, mortar hoses, mortar strainers, etc.; as construction auxiliary materials such as rubber sheets, air hoses, etc.; safety measures products such as rubber buoys and wave extinguishers; as environmental conservation goods such as oil fences, silt fences, antifouling materials, marine hoses, dredging hoses, oil skimmers, etc. In addition, the radically curable composition and cured product according to one or more embodiments of the present invention can be used for plate rubbers, mats, foam boards and the like.

In addition, for applications where vibration proofing materials, vibration damping materials, sound insulation materials, and seismic isolation materials are particularly required, the radically curable composition and cured product according to one or more embodiments of the present invention can be used in electrical and electronic device applications, such as for a damping material in a stepping motor, a magnetic disk, a hard disk, a dishwasher, a speaker frame, a BS antenna, and a VTR cover, architectural applications, such as in a roof flooring, a shutter, a curtain rail, a floor, a plumbing duct, a deck plate, a curtain wall, stairs, a door, a seismic isolator, and a structural damping material; building applications, such as a viscoelastic damper and a seismic resisting material; marine applications, such as a damping material in an engine room or a measurement room; automotive applications, such as for a damping material in an engine (oil pan, front cover, rocker cover), a car body (dashboard, floor, doors, roof panels, wheel house), a transmission, a parking brake cover, and a damping material for seat back; camera and office equipment applications, such as a damping material for a TV camera, a copying machine, a computer, a printer, a cash register, and a cabinet; industrial machine applications, such as for a damping material in a shooter, an elevator, an escalator, a conveyor, a tractor, a bulldozer, a power generator, a compressor, a container, a hopper, a soundproof box, and lawn mower motor cover, railway applications, such as a damping material in a railway carriage roof, a side plate, a door, an underfloor, various auxiliary covers, and a bridge; a damping material for precision anti-vibration equipment for semiconductor applications and the like; and for a damping material for soundproofing of low-frequency sounds and high-frequency sounds near the audible threshold region.

Besides, the cured product of one or more embodiments of the present invention can be used as a molded article for packings, O rings, belts, tubes, hoses, valves, sheets, and the like.

Further, the radically curable composition and cured product according to one or more embodiments of the present invention can also be used as various kinds of adhesives, such as a reactive hot melt agent for a wiring connector, a reactive hot melt adhesive, an OCA (optically transparent adhesive), an elastic adhesive, a contact adhesive, an anaerobic adhesive, an adhesive for tiles, a UV-ray curable adhesive, an electron beam curable adhesive, an adhesive for a touch panel and a touch sensor, and the like.

The radically curable composition and cured product according to one or more embodiments of the present invention can be used in the modification of butyl-based pressure sensitive adhesive or as various pressure-sensitive adhesives, such as, masking tapes, pipe anticorrosion tapes, building water stop tapes, electric self-fusion tapes, removable pressure sensitive adhesives, electric wire fusion tapes and the like.

The radically curable composition and cured product according to one or more embodiments of the present invention can be used in various coating applications, such as for an electric wire, cable, or optical fiber covering material or repair material thereof an insulation sealing material for a wire connection portion, a tube inner liner for a gas pipe or a water pipe, a coating material for an inorganic filler and an organic filler, a release material for a molding in an epoxy mold and the like.

The radically curable composition and cured product according to one or more embodiments of the present invention can be used as various sheets, such as a heat conduction sheet, a heat dissipation sheet, an electromagnetic wave absorption sheet, a conductive sheet, a waterproof sheet, an automotive protective sheet, a panel shock absorbing sheet, and the like.

The radically curable composition and cured product according to one or more embodiments of the present invention can be used for a shock absorbing gel, an impact absorbing material in beds, shoes and the like, an intermediate layer film for laminated glass, a paint such as an elastic paint or an aqueous emulsion, a prepreg, various rollers for OA equipment and conveyance equipment, a cap liner, an ink repellent, ink, sealing materials for various refrigerant, a sealing material or gasket for industrial and food cans, a foam gasket, a paint, a powder paint, a foam, a can lid, a film, a gasket, a marine deck coking, a casting material, various molding materials and an artificial marble.

The radically curable composition and cured product according to one or more embodiments of the present invention can also be used for resist applications such as dry film resist applications and electrodeposition resist applications.

However, it is obvious that the cured product of one or more embodiments of the present invention is not limited to the above-mentioned applications.

### EXAMPLE

Hereinafter, specific examples of one or more embodiments of the present invention will be described together with comparative examples, but the present invention is not limited to the following examples. “Number average molecular weight” and “molecular weight distribution (ratio of weight average molecular weight to number average molecular weight)” were calculated by standard polystyrene conversion method using gel permeation chromatography (GPC). However, a column packed with a polystyrene crosslinked gel was used as a GPC column (shodex GPC K-804. K-802.5; manufactured by Showa Denko K.K.) and chloroform was used as a GPC solvent.

The number of functional groups introduced per one molecule of the polymer was calculated based on concentration analysis by ¹H-NMR and number average molecular weight determined by GPC. However, NMR was measured at 23° C. using an ASX-400 manufactured by Bruker Corporation and deuterated chloroform as a solvent.

### (Synthesis Example 1) Synthesis Example of Poly(n-Butyl Acrylate) Polymer [P1] Having Acryloyl Group

In accordance with a known method (for example, the method described in JP-A-2012-211216), cuprous bromide as a catalyst, pentamethyldiethylenetriamine as a ligand, diethyl-2,5-dibromoadipate as an initiator, and n-butyl acrylate as a monomer were subjected to polymerization at a ratio of (n-butyl acrylate)/(diethyl-2,5-dibromoadipate) of 160 to obtain a bromine-terminated poly(n-butyl acrylate).

This polymer was dissolved in N. N-dimethylacetamide, potassium acrylate was added thereto, and the mixture was heated with stirring at 70° C. in a nitrogen atmosphere. After distilling off the N, N-dimethylacetamide in the mixture under reduced pressure, butyl acetate was added to the residue, and an insoluble matter was removed by filtration. The butyl acetate in the filtrate was distilled off under reduced pressure to obtain a poly(n-butyl acrylate) polymer [P] having acryloyl groups at both terminals.

The number average molecular weight of the polymer [P1] was 23,000, and the molecular weight distribution thereof was 1.1. The average number of acryloyl groups introduced per one molecule of the polymer [P1] was found to be about 1.9 as determined by ¹H-NMR analysis.

### (Synthesis Example 2) Synthesis Example of Poly(n-Butyl Acrylate) Polymer [P2] Having Acryloyl Group

A poly(n-butyl acrylate) polymer [P2] having an acryloyl group at one terminal was obtained in the same manner as in Synthesis Example 1, except that ethyl a-bromobutyrate was used as an initiator and the monomer/initiator ratio was set to 80.

The number average molecular weight of the polymer [P2] was 12.000, the molecular weight distribution was 1.1, and the average number of acryloyl groups introduced per one molecule of the polymer [P2] was found to be about 0.9 as determined by ¹H-NMR analysis.

### (Synthesis Example 3) Synthesis Example of Poly(n-Butyl Acrylate)/(Ethyl Acrylate)/(Methoxyethyl Acrylate) Copolymer [P3] Having Acryloyl Group

A poly(n-butyl acrylate)/(ethyl acrylate)/(methoxyethyl acrylate) copolymer [P3] having acryloyl groups at both terminals was obtained in the same manner as in Synthesis Example 1, except that n-butyl acrylate/ethyl acrylate/methoxyethyl acrylate (73 parts/25 parts/2 parts) were used as the monomer, and the monomer/initiator ratio was set to 240.

The number average molecular weight of the copolymer [P3] was about 35,000 and the molecular weight distribution thereof was 1.3. The average number of acryloyl groups introduced per one molecule of the polymer [P3] was found to be about 2.0 as determined by ¹H-NMR analysis.

### (Synthesis Example 4) Synthesis Example of Poly(n-Butyl Acrylate)/(2-Ethylhexyl Acrylate) Copolymer [P4] Having Acryloyl Group

A poly(n-butyl acrylate)/(2-ethylhexyl acrylate) copolymer [P4] having acryloyl groups at both terminals was obtained in the same manner as in Synthesis Example 1, except that n-butyl acrylate/2-ethylhexyl acrylate (50 parts/50 parts) were used as the monomer and the monomer/initiator ratio was set to 400.

The number average molecular weight of the copolymer [P4] was about 60,000 and the molecular weight distribution thereof was 1.4. The average number of acryloyl groups introduced per one molecule of the polymer [P4] was found to be about 1.8 as determined by ¹H-NMR analysis.

<Physical Property Evaluation Method>

The dynamic viscoelasticity of the cured products prepared in examples and comparative examples was evaluated according to the following methods and conditions.

(Dynamic Viscoelasticity)

Measurement for dynamic viscoelasticity was performed at a frequency of 0.5 Hz, a strain of 0.05% and a shearing mode in a range of −100° C. to 150° C. with a dynamic viscoelasticity measuring device DVA-200 manufactured by IT Keisoku Seigyo K.K. The tan δ was calculated as tan δ=loss elastic modulus/storage elastic modulus, and the lower limit temperature (° C.) and the upper limit temperature (° C.) in the temperature region where tan δ exceeded 0.5 were determined. The upper limit temperature (° C.)-the lower limit temperature (° C.) was regarded as the temperature range (OC) in the temperature region where tan δ exceeded 0.5.

### Example 1

To 100 parts by weight of the polymer [P1] obtained in Synthesis Example 1 were added 10 parts of BEAMSET 101 (rosin epoxy acrylate, manufactured Arakawa Chemical Industries, Ltd.), 1 part by weight of TMP 3A (trimethylolpropane triacrylate, manufactured by Osaka Organic Chemical Industry Ltd.) as a reactive diluent, 0.1 parts by weight of IRGANOX 1010 (hindered phenol-based antioxidant, manufactured by BASF Japan) as an antioxidant, and 0.3 parts by weight of IRGACURE 819 (bis(2,4,6-trimethylbenzoyl)-phenylphosphine oxide, manufactured by BASF Japan) as a radical photoinitiator, and after thoroughly mixing, the mixture was degassed to obtain a radically-curable composition. This composition was poured into a polypropylene formwork so as to have a thickness of 2 mm and subjected to UV irradiation in the air to obtain a cured rubber sheet. For UV irradiation, a model LH6, H valve, manufactured by Fusion UV Systems Japan K.K., was used A UV light meter made by EIT, 4 band UV measuring instrument UV POWER PUCK II was used, and the measurement value of UVA (320-290 nm) was used as a light receiving sensor. Irradiation conditions were 400 mW/cm² in illuminance and 6000 mJ/cm² in light intensity. The dynamic viscoelasticity of the obtained cured product was measured. The results are shown in Table 1.

TABLE 1

| | | Example 1 | Example 2 | Example 3 | Example 4 |
|---|---|---|---|---|---|
| (Meth)acrylic polymer | Polymer [P1] | 100 | 100 | 100 | 100 |
| (Meth)acrylate compound | BEAMSET 101 | 10 | 30 | 70 | 100 |
| having rosin ester group | | | | | |
| Reactive diluent | TMP3A | 1 | | 5 | 10 |
| Antioxidant | IRGANOX1010 | 0.1 | | 0.1 | 0.1 |
| Radical polymerization | IRGACURE819 | 0.3 | 0.3 | 0.3 | 0.3 |
| initiator | | | | | |
| Temperature region where | Lower limit temperature | −37 | −34 | −27 | −27 |
| tan δ exceeds 0.5 | (° C.) | | | | |
| | Upper limit temperature | 49 | 108 | 122 | 109 |
| | (° C.) | | | | |
| | Temperature range (° C.) | 86 | 142 | 149 | 136 |

### Examples 2 to 4

In the same manner as in Example 1, radically curable compositions each having the formulation shown in Table 1 were prepared to obtain cured rubber sheets each having a thickness of 2 mm. The dynamic viscoelasticity of each of the obtained cured products was measured. The results are shown in Table 1.

### Comparative Examples 1 to 8

In the same manner as in Example 1, radically curable compositions each having the formulation shown in Table 2 were prepared to obtain cured rubber sheets each having a thickness of 2 mm. The dynamic viscoelasticity of each of the obtained cured products was measured. The results are shown in Table 2.

TABLE 2

| | | Comparative | Comparative | Comparative | Comparative | Comparative | Comparative | Comparative | Comparative |
|---|---|---|---|---|---|---|---|---|---|
| | | Example 1 | Example 2 | Example 3 | Example 4 | Example 5 | Example 6 | Example 7 | Example 8 |
| (Meth)acrylic | Polymer [P1] | 100 | | | | | | 100 | 100 |
| polymer | Copolymer [P4] | | 100 | 100 | 100 | 100 | 100 | | |
| Reactive | INAA | | | 50 | | | | | |
| diluent | LA | | | | 50 | | | | |
| | ISTA | | | | | 50 | | | |
| | FA513AS | | | | | | 50 | | |
| | IBXA | | | | | | | 30 | 50 |
| Antioxidant | IRGANOX1010 | 1 | | | | | | 0.1 | 0.1 |
| Radical | DAROCUR1173 | 0.2 | 0.2 | 0.2 | 0.2 | 0.2 | 0.2 | | |
| polymerization | IRGACURE819 | 0.1 | 0.1 | 0.1 | 0.1 | 0.1 | 0.1 | 0.2 | 0.2 |
| initiator | | | | | | | | | |
| Temperature | Lower limit | −42 | −49 | −49 | −54 | −49 | −43 | −24 | 4 |
| region | temperature (° C.) | | | | | | | | |
| where tan δ | Upper limit | −3 | −1 | −1 | 7 | −12 | 10 | 40 | 59 |
| exceeds 0.5 | temperature (° C.) | | | | | | | | |
| | Temperature | 39 | 48 | 48 | 61 | 37 | 53 | 64 | 55 |
| | range (° C.) | | | | | | | | |

From the comparison between Table 1 and Table 2, the following points are obvious. In the cured products (Comparative Examples 1 and 2) of only the polymer [P1] or the copolymer [P4], the temperature region where tan S exceeds 0.5 is extremely narrow (39° C. 48° C.). In the case of adding a common monomer as a reactive diluent (Comparative Examples 3 to 7), the improvement in the temperature region where tan S exceeds 0.5 is limited (64° C. at the maximum), and this is not a sufficient temperature range. Further, the temperature (upper limit temperature) at which tan δ becomes 0.5 or less at high temperature is mostly room temperature or lower (Comparative Examples 1 to 8) and is limited to be 60° C. or lower even at the highest temperature (Comparative Example 7, temperature range is 55° C.). On the other hand, when 10 parts by weight to 100 parts by weight of the (meth)acrylate compound having a rosin ester group according to one or more embodiments of the present invention is used (Examples 1 to 4), the region where tan δ exceeds 0.5 is from a low temperature of −20° C. or lower to a high temperature of 45° C. or higher, which is a very wide temperature range (86 to 148° C.). The (meth)acrylate compound having a rosin ester group of one or more embodiments of the present invention has excellent vibration damping properties and impact absorption properties in this wide temperature range. In addition, reactive diluents such as INAA and IBXA were odorous, so that the working environment remarkably deteriorated during kneading. BEAMSET 101 that is a liquid is easily mixed, has little odor, and did not deteriorate the surrounding work environment.

### Comparative Examples 9 to 12

In the same manner as in Example 1, radically curable compositions each having the formulation shown in Table 3 were prepared to obtain cured rubber sheets each having a thickness of 2 mm. The dynamic viscoelasticity of each of the obtained cured products was measured. The results are shown in Table 3.

TABLE 3

| | | Comparative | Comparative | Comparative | Comparative |
|---|---|---|---|---|---|
| | | Example 9 | Example 10 | Example 11 | Example 12 |
| (Meth)acrylic | Polymer [P1] | 100 | 100 | 100 | 100 |
| polymer | | | | | |
| Reactive diluent | TMP3A | 1 | 1 | 1 | 1 |
| Tackifying resin | YS Polystar TH130 | 10 | 20 | | |
| | PINECRYSTAL KE- | | | 20 | |
| | 100 | | | | |
| | PINECRYSTAL KE- | | | | 20 |
| | 615-3 | | | | |
| Radical | DAROCUR1173 | 0.2 | | | |
| polymerization | IRGACURE819 | 0.1 | 0.2 | 0.2 | 0.2 |
| initiator | | | | | |
| Temperature region | Lower limit temperature | −33 | −27 | −29 | −39 |
| where | (° C.) | | | | |
| tan δ exceeds 0.5 | Upper limit temperature | 10 | 37 | 36 | 13 |
| | (° C.) | | | | |
| | Temperature range (° C.) | 43 | 64 | 65 | 52 |

In the case of using terpene phenol-based tackifying resins (Comparative Examples 9 and 10) and rosin-based tackifying resins (Comparative Examples 11 and 12) known as tackifying resins, a dangerous and burdensome process was necessary such that the tackifying resin was melted at a high temperature and then kneaded. In addition, the temperature range in the temperature region where tan δ of the obtained cured product exceeded 0.5 was 43 to 65° C., which was a limited improvement degree. In the case of using a liquid rosin resin (Comparative Example 12), no issues related to kneading process occurred, but the improvement of the temperature region in which tan δ of the obtained cured product exceeded 0.5 was similarly limited (52° C.).

### Comparative Examples 13 to 19

In the same manner as in Example 1, radically curable compositions each having the formulation shown in Table 4 were prepared to obtain cured rubber sheets each having a thickness of 2 mm. The dynamic viscoelasticity of each of the obtained cured products was measured. The results are shown in Table 4.

TABLE 4

| | | Comparative | Comparative | Comparative | Comparative | Comparative | Comparative | Comparative |
|---|---|---|---|---|---|---|---|---|
| | | Example 13 | Example 14 | Example 15 | Example 16 | Example 17 | Example 18 | Example 19 |
| (Meth)acrylic | Polymer [P1] | 100 | 100 | 100 | 100 | 100 | 100 | 60 |
| polymer | Polymer [P2] | | | | | | | 40 |
| Reactive diluent | LA | 30 | | | | | | |
| | ISTA | | 30 | | | | | |
| | ACMO | | | 30 | | | | |
| | IBXA | | | | 30 | | 20 | 30 |
| | LIGHT ACRYLATE 130A | | | | | 30 | | |
| | TMP3A | 1 | 1 | 1 | 1 | 1 | 1 | 1 |
| Tackifying resin | YS Polystar TH130 | 20 | 20 | 20 | 20 | 20 | 10 | |
| | PINECRYSTAL KE-615-3 | | | | | | | 30 |
| Antioxidant | IRGANOX1010 | | | | | | 0.1 | 0.1 |
| Radical | IRGACURE819 | 0.2 | 0.2 | 0.2 | 0.2 | 0.2 | 0.2 | 0.3 |
| polymerization | | | | | | | | |
| initiator | | | | | | | | |
| Temperature region | Lower limit temperature | −35 | −27 | −15 | −15 | −32 | −24 | −27 |
| where | (° C.) | | | | | | | |
| tan δ exceeds 0.5 | Upper limit temperature | 37 | 50 | 17 | 63 | 39 | 39 | 52 |
| | (° C.) | | | | | | | |
| | Temperature range (° C.) | 72 | 77 | 32 | 78 | 71 | 63 | 79 |

As is apparent from Table 4, in the case where a common acrylic monomer hitherto known as a reactive diluent and a tackifying resin are used in combination (Comparative Examples 13 to 19), the temperature region where tan δ exceeds 0.5 tends to be more improved (63 to 79° C.) than when used alone, but the temperature is insufficient because it is lower than 80° C., which does not exceed the effect (80° C. or more) exerted by the (meth)acrylate compound having a rosin ester group. That is, the degree of improvement is limited only by adding a common acrylate monomer and a tackifying resin, which have hitherto been known as a technique for controlling the viscoelastic behavior of a cured product, and it is obvious that a large effect is exerted by adding a compound having a rosin ester group and a (meth)acrylate group in one molecule.

### Comparative Examples 20 and 21

In the same manner as in Example 1, radically curable compositions each having the formulation shown in Table 5 were prepared to obtain cured rubber sheets each having a thickness of 2 mm. The dynamic viscoelasticity of each of the obtained cured products was measured. The results are shown in Table 5.

TABLE 5

| | | Comparative | Comparative |
|---|---|---|---|
| | | Example 20 | Example 21 |
| (Meth)acrylic polymer | Copolymer [P4] | 100 | 100 |
| (Meth)acrylate | BEAMSET 101 | 5 | 2 |
| compound having | | | |
| rosin ester group | | | |
| Reactive diluent | TMP3A | 5 | 5 |
| Tackifying resin | PINECRYSTAL | | |
| | KE-100 | | |
| Antioxidant | IRGANOX1010 | 0.1 | 0.1 |
| Radical polymerization | IRGACURE819 | 0.3 | 0.3 |
| initiator | | | |
| Temperature region | Lower limit | −48 | −48 |
| where tan δ | temperature | | |
| exceeds 0.5 | (° C.) | | |
| | Upper limit | 9 | −2 |
| | temperature | | |
| | (° C.) | | |
| | Temperature range | 57 | 46 |
| | (° C.) | | |

As shown in Comparative Examples 20 and 21, when the amount of the (meth)acrylate compound having a rosin ester group used in one or more embodiments of the present invention is insufficient (2 to 5 parts by weight), the degree of improvement is limited (60C or lower), which is not significantly different from the improvement effect by conventionally known means.

### Comparative Examples 22 to 30

In the same manner as in Example 1, radically curable compositions each having the formulation shown in Table 6 were prepared to obtain cured rubber sheets each having a thickness of 2 mm. The dynamic viscoelasticity of each of the obtained cured products was measured. The results are shown in Table 6.

TABLE 6

| | | Compar- | Compar- | Compar- | Compar- | Compar- | Compar- | Compar- | Compar- | Compar- |
|---|---|---|---|---|---|---|---|---|---|---|
| | | ative | ative | ative | ative | ative | ative | ative | ative | ative |
| | | Example | Example | Example | Example | Example | Example | Example | Example | Example |
| | | 22 | 23 | 24 | 25 | 26 | 27 | 28 | 29 | 30 |
| Polyurethane acrylate | EBECRYL230 | 100 | 100 | 100 | 100 | | | | | |
| resin | EBECRYL210 | | | | | 100 | 100 | 100 | | |
| Polyester acrylate resin | EBECRYL810 | | | | | | | | 100 | 100 |
| (Meth)actylate | BEAMSET 101 | 25 | 30 | 30 | 30 | 30 | 30 | 30 | 30 | 30 |
| compound having | | | | | | | | | | |
| rosin ester group | | | | | | | | | | |
| Reactive diluent | TMP3A | 1 | | | | | | | | |
| | LA | | | 30 | | | 30 | | 30 | |
| | LIGHT | | | | 30 | | | 30 | | 30 |
| | ACRYLATE | | | | | | | | | |
| | 130A | | | | | | | | | |
| Tackifying resin | PINECRYSTAL | 15 | | | | | | | | |
| | KE-100 | | | | | | | | | |
| Antioxidant | IRGANOX1010 | 0.1 | | | | | | | | |
| Radical polymerization | DAROCUR1173 | | 0.2 | 0.2 | 0.2 | 0.2 | 0.2 | 0.2 | 0.2 | 0.2 |
| initiator | IRGACURE819 | 0.3 | 0.1 | 0.1 | 0.1 | 0.1 | 0.1 | 0.1 | 0.1 | 0.1 |
| Temperature region | Lower limit | −36 | −37 | −50 | −45 | −3 | −17 | −18 | 14 | −73 |
| where | temperature (° C.) | | | | | | | | | |
| tan δ exceeds 0.5 | Upper limit | 17 | 20 | 3 | −1 | 34 | 17 | 14 | 15 | −17 |
| | temperature (° C.) | | | | | | | | | |
| | Temperature | 53 | 57 | 53 | 44 | 37 | 34 | 32 | 1 | 56 |
| | range (° C.) | | | | | | | | | |

As shown in Comparative Examples 22 to 30, when a polyurethane resin having an acryloyl group which is a radically-crosslinkable group (polyurethane acylate resin), or a polyester resin having an acryloyl group (polyester acrylate resin) was used instead of the (meth)acrylic polymer having a radically-crosslinkable group, the temperature range in the temperature region where tan δ exceeded 0.5 was as narrow as 60° C. or lower. That is, the effect of one or more embodiments of the present invention is exerted only when the (meth)acrylic polymer having a radically-crosslinkable group is used, and even if other resins are used, it cannot be expected to obtain the same effect.

### Examples 5 to 12 and 13 to 27

In the same manner as in Example 1, radically curable compositions each having the formulation shown in Tables 7 and 8 were prepared to obtain rubber sheets each having a thickness of 2 mm. The dynamic viscoelasticity of each of the obtained cured products was measured. The results are shown in Tables 7 and 8. For Examples 5 to 12, the maximum value of tan δ and the tan δ values at frequencies of 5 Hz and 50 Hz at 23° C. were determined, together with the lower limit temperature (° C.) and the upper limit temperature (° C.) in the temperature region where tan δ exceeded 0.5 and the temperature range (° C.) in the temperature region where tan δ exceeded 0.5. The results are shown in Table 7.

TABLE 7

| | | | | | | | Example | Example | Example |
|---|---|---|---|---|---|---|---|---|---|
| | | Example 5 | Example 6 | Example 7 | Example 8 | Example 9 | 10 | 11 | 12 |
| (Meth)acrylic | Polymer [P1] | 100 | 100 | 100 | 100 | 100 | 60 | | 100 |
| polymer | Polymer [P2] | | | | | | 40 | | |
| | Copolymer [P3] | | | | | | | 100 | |
| (Meth)acrylate | BEAMSET 101 | 30 | 30 | 30 | 30 | 25 | 25 | 25 | 25 |
| compound having | | | | | | | | | |
| rosin ester group | | | | | | | | | |
| Polyuethane acrylate | EBECRYL230 | | 10 | | | | | | |
| resin | | | | | | | | | |
| Reactive diluent | TMP3A | 5 | 1 | 5 | 1 | 1 | 1 | 1 | 1 |
| | FA513AS | | | 5 | | | | | 30 |
| | IBXA | | 20 | 10 | | 30 | 30 | 30 | |
| | ISTA | | | 5 | | | | | |
| | LA | | | 5 | | | | | |
| Tackifying resin | PINECRYSTAL KE-100 | 15 | | | | 15 | 15 | 15 | 15 |
| Antioxidant | IRGANOX1010 | 0.1 | 0.1 | 0.1 | 0.1 | 0.1 | 0.1 | 0.1 | 0.1 |
| | Sumilizer GA-80 | | | | 0.1 | | | | |
| | IRGANOX PS800 | | | | 0.1 | | | | |
| Radical | IRGACURE819 | 0.3 | 0.3 | 0.3 | 0.3 | 0.3 | 0.3 | 0.3 | 0.3 |
| polymerization | | | | | | | | | |
| initiator | | | | | | | | | |
| Temperature region | Lower limit temperature (° C.) | −25 | −31 | −32 | −34 | −23 | −24 | −22 | −28 |
| where tan δ exceeds | Upper limit temperature (° C.) | 90 | 53 | 49 | 109 | 69 | 80 | 97 | 67 |
| 0.5 | Temperature range (° C.) | 115 | 84 | 81 | 143 | 92 | 103 | 119 | 95 |
| Maximum tan δ | | 1.3 | 1.1 | 0.9 | 1.4 | 1.2 | 1.4 | 1.0 | 0.9 |
| Tan δ at 23° C. | 5 Hz | 1.23 | 0.99 | 0.84 | 1.41 | 1.18 | 1.41 | 0.93 | 0.84 |
| | 50 Hz | 1.21 | 1.10 | 0.87 | 1.22 | 1.27 | 1.44 | 0.90 | 0.82 |

TABLE 8

| | | Example | Example | Example | Example | Example | Example | Example | Example |
|---|---|---|---|---|---|---|---|---|---|
| | | 13 | 14 | 15 | 16 | 17 | 18 | 19 | 20 |
| (Meth)acrylic | Copolymer [P4] | 100 | 100 | 100 | 100 | 100 | 100 | 100 | 100 |
| polymer | | | | | | | | | |
| (Meth)acrylate | BEAMSET 101 | 10 | 10 | 15 | 15 | 20 | 20 | 25 | 25 |
| compound | | | | | | | | | |
| having rosin | | | | | | | | | |
| ester group | | | | | | | | | |
| Reactive | TMP3A | 1 | 1 | 1 | 1 | 1 | 1 | 1 | 1 |
| diluent | IBXA | | 30 | 30 | 30 | 30 | 30 | 30 | 30 |
| | LA | | | | | | | | 5 |
| Tackifying | PINECRYSTAL | | | | | | | | |
| resin | KR-140 | | | | | | | | |
| | PINECRYSTAL | | | | | | | | |
| | KE-100 | | | | | | | | |
| | YS Polystar | | | 15 | 25 | | 20 | 15 | 15 |
| | TH130 | | | | | | | | |
| Antioxidant | IRGANOX1010 | 0.1 | 0.1 | 0.1 | 0.1 | 0.1 | 0.1 | 0.1 | 0.1 |
| Radical | IRGACURE819 | 0.3 | 0.3 | 0.3 | 0.3 | 0.3 | 0.3 | 0.3 | 0.3 |
| polymerization | | | | | | | | | |
| initiator | | | | | | | | | |
| Temperature | Lower limit | −45 | −31 | −28 | −21 | −31 | −30 | −27 | −27 |
| region where | temperature (° C.) | | | | | | | | |
| tan δ | Upper limit | 149 | 136 | 130 | 143 | 109 | 147 | 137 | 126 |
| exceeds 0.5 | temperature (° C.) | | | | | | | | |
| | Temperature | 194 | 167 | 158 | 164 | 140 | 177 | 164 | 152 |
| | range (° C.) | | | | | | | | |

| | | Example | Example | Example | Example | Example | Example | Example |
|---|---|---|---|---|---|---|---|---|
| | | 21 | 22 | 23 | 24 | 25 | 26 | 27 |
| (Meth)acrylic | Copolymer [P4] | 100 | 100 | 100 | 100 | 100 | 100 | 100 |
| polymer | | | | | | | | |
| (Meth)acrylate | BEAMSET 101 | 25 | 25 | 25 | 25 | 30 | 40 | 40 |
| compound | | | | | | | | |
| having rosin | | | | | | | | |
| ester group | | | | | | | | |
| Reactive | TMP3A | 1 | 1 | 1 | 1 | 1 | 1 | 1 |
| diluent | IBXA | 30 | 30 | 30 | 30 | 30 | 30 | 30 |
| | LA | 10 | | | | | | |
| Tackifying | PINECRYSTAL | | 10 | | | | | |
| resin | KR-140 | | | | | | | |
| | PINECRYSTAL | | | 15 | | | | |
| | KE-100 | | | | | | | |
| | YS Polystar | 15 | | | 15 | | | 10 |
| | TH130 | | | | | | | |
| Antioxidant | IRGANOX1010 | 0.1 | 0.1 | 0.1 | 0.1 | 0.1 | 0.1 | 0.1 |
| Radical | IRGACURE819 | 0.3 | 0.3 | 0.3 | 0.3 | 0.3 | 0.3 | 0.3 |
| polymerization | | | | | | | | |
| initiator | | | | | | | | |
| Temperature | Lower limit | −30 | −31 | −29 | −30 | −29 | −51 | −38 |
| region where | temperature (° C.) | | | | | | | |
| tan δ | Upper limit | 114 | 136 | 138 | 146 | 119 | 129 | 141 |
| exceeds 0.5 | temperature (° C.) | | | | | | | |
| | Temperature | 144 | 167 | 167 | 176 | 148 | 180 | 179 |
| | range (° C.) | | | | | | | |

As is apparent from Tables 7 and 8, by using the (meth)acrylic polymer having a radically-crosslinkable group and the (meth)acrylate compound having a rosin ester group, a high tan δ can be achieved in a wide temperature range of 80° C. or higher. Further, from Table 7, the maximum values of tan δ of the obtained cured products are all 1.4 or less. Furthermore, since there is almost no change in the tan δ values at frequencies of 5 Hz and 50 Hz at 23° C., the dynamic viscoelasticity is small in frequency dependence, and the effect of the vibration damping property and impact absorbing property with less change in a wide frequency region is obtained. Thus, there is an advantage that it is easy to perform the design as the vibration damping material or the impact absorbing material.

### Example 28

Using the cured product obtained in Example 16, dynamic viscoelasticity was measured at various frequencies at a constant temperature (23° C.). The measurement was carried out at a frequency of 0.5 to 100 Hz and a strain of 0.05% in a shear mode. The results are shown in Table 9.

TABLE 9

| | Example 28 | | | | | | | |
|---|---|---|---|---|---|---|---|---|
| | Frequency (Hz) | | | | | | | |
| | 0.5 | 1 | 2 | 5 | 10 | 20 | 50 | 100 |
| tan δ | 0.99 | 0.99 | 0.98 | 0.98 | 0.97 | 0.96 | 0.96 | 0.96 |

As described above, the rubber elastic body (Example 16, lower limit temperature −21° C., upper limit temperature 143° C.) exhibiting a high tan δ in a wide temperature range shows a high tan δ even in a wide frequency range at a certain constant temperature. That is, since such a material has a high vibration damping property from the low frequency region below the decimal point to the high frequency vibration region of 100 Hz as well as the change in the value due to frequency is small, the same degree of vibration damping property and impact absorbing effect can be expected in a wide frequency range. Thus, there is an advantage that it is easy to design as a vibration damping material or impact absorbing material.

### Example 29

To 100 parts by weight of the polymer [P4] obtained in Synthesis Example 4 were added 30 parts of BEAMSET 101 (rosin epoxy acrylate, manufactured by Arakawa Chemical Industries, Ltd.), 5 parts by weight of TMP3A (trimethylolpropane triacrylate, manufactured by Osaka Organic Chemical Industry Ltd.) as a reactive diluent, 20 parts by weight of IBXA (isobornyl acrylate, manufactured by Osaka Organic Chemical Industry Ltd), 0.1 parts by weight of IRGANOX 1010 (hindered phenol-based antioxidant manufactured by BASF Japan,) as an antioxidant, 0.1 parts by weight of IRGACURE 819 (bis(2,4,6-trimethylbenzoyl)-phenylphosphine oxide, manufactured by BASF Japan) as a radical photoinitiator, 0.2 parts by weight of DAROCUR 1173 (2-hydroxy-2-methyl-1-phenylpropan-1-one, manufactured by BASF Japan), 0.1 parts by weight of IRGACURE 184 (1-hydroxy-cyclohexyl-phenyl-ketone manufactured by BASF Japan) and 0.1 parts by weight of IRGACURE 379 (2-(4-methylbenzyl)-2-dimethylamino-1-(4-morpholine-4-yl-phenyl)-butan-1-one, manufactured by BASF Japan (total 0.5 parts by weight as a radical photoinitiator), and the obtained mixture was sufficiently mixed and defoamed to prepare a radically curable composition, which was treated in the same manner as in Example 1 to obtain a cured rubber sheet having a thickness of 2 mm. The dynamic viscoelasticity of the obtained cured product was measured. The lower limit temperature in the temperature region where tan δ exceeded 0.5 was −37° C., the upper limit temperature was 110° C. and thus the temperature range in the temperature region where tan δ exceeded 0.5 was 147° C.

### Example 30

To 100 parts by weight of the polymer [P1] obtained in Synthesis Example 1 were added 30 parts of BEAMSET 101 (rosin epoxy acrylate, manufactured by Arakawa Chemical Industries, Ltd.), 5 parts by weight of TMP3A (trimethylolpropane triacrylate, manufactured by Osaka Organic Chemical Industry Ltd.) as a reactive diluent, 30 parts by weight of ISTA (isostearyl acrylate, manufactured by Osaka Organic Chemical Industry Ltd.), 0.1 parts by weight of IRGANOX 1010 (hindered phenol-based antioxidant, manufactured by BASF Japan) as an antioxidant, and 0.5 parts by weight of PERCUMYL D (dicumyl peroxide, manufactured by NOF Corporation) as a thermal radical initiator, and the obtained mixture was sufficiently mixed and dissolved, and defoamed to prepare a radically curable composition. This curable composition was heated in a mold at 180° C. for 10 minutes to obtain a cured rubber sheet having a thickness of 2 mm. The dynamic viscoelasticity of the obtained cured product was measured. The results are shown in Table 10.

TABLE 10

| | | Example 30 | Example 31 | Example 32 | Example 33 | Example 34 | Example 35 | Example 36 |
|---|---|---|---|---|---|---|---|---|
| (Meth)acrylic polymer | Polymer [P1] | 100 | 40 | 100 | 100 | 100 | | |
| | Polymer [P2] | | 60 | | | | | |
| | Copolymer [P3] | | | | | | 100 | |
| | Copolymer [P4] | | | | | | | 100 |
| (Meth)acrylate | BEAMSET 101 | 30 | 30 | 30 | 30 | 50 | 30 | 30 |
| compound having rosin | | | | | | | | |
| ester group | | | | | | | | |
| Reactive diluent | TMP3A | 5 | 5 | 5 | 5 | 5 | 5 | 5 |
| | ISTA | 30 | | | 20 | | | |
| Tackifying resin | YS Polystar | | | 15 | | | | |
| | TH130 | | | | | | | |
| Antioxidant | IRGANQX1010 | 0.1 | 0.1 | 0.1 | 0.1 | 0.1 | 0.1 | 0.1 |
| Radical polymerization | PERCUMYL D | 0.5 | 0.5 | 0.5 | 0.5 | 0.5 | 0.5 | 0.5 |
| initiator | | | | | | | | |
| Temperature region | Lower limit | −28 | −33 | −24 | −31 | −25 | −29 | −40 |
| where | temperature (° C.) | | | | | | | |
| tan δ exceeds 0.5 | Upper limit | 61 | 60 | 64 | 54 | 57 | 61 | 85 |
| | temperature (° C.) | | | | | | | |
| | Temperature range | 89 | 93 | 88 | 85 | 82 | 90 | 125 |
| | (° C.) | | | | | | | |

### Examples 31 to 36

In the same manner as in Example 30, radically curable compositions each having the formulation shown in Table 10 were prepared to obtain cured rubber sheets each having a thickness of 2 mm. In Examples 32 to 36, the compositions were heated in a mold at 180° C. for 5 minutes to obtain cured sheets. The dynamic viscoelasticity of each of the obtained cured products was measured. The results are shown in Table 10.

Each of the cured products obtained by heat curing also exhibited a high tan δ value in a wide temperature range (82 to 125° C.) similarly to the cured product obtained by photo-radical curing.

The compounds listed in the tables are as follows.

### <Polyurethane Acrylate Resin>

EBECRYL 230: Aliphatic urethane acrylate, manufactured by Daicel-Allnex Ltd.

EBECRYL 210: Aromatic urethane acrylate, manufactured by Daicel-Allnex Ltd.

### <Polyester Acrylate Resin>

EBECRYL 810: Polyester acrylate, manufactured by Daicel-Allnex Ltd.

### <(Meth)Acrylate Compound Having Rosin Ester Group>

BEAMSET 101: Rosin epoxy acylate (1-acrylic acid-3-dehydroabietic acid-2-hydroxypropyl), manufactured by Arakawa Chemical Industries Ltd.

### <Reactive Diluent>

TMP 3A: Trimethylolpropane triacrylate, manufactured by Osaka Organic Chemical Industry Ltd.

INAA Isononyl acrylate, manufactured by Osaka Organic Chemical Industry Ltd.

LA: Lauryl acrylate, manufactured by Kyoei Chemical Co., Ltd.

ISTA: Isostearyl acrylate, manufactured by Osaka Organic Chemical Industry Ltd.

FA 513 AS: FANCRYL FA-513 AS, Dicyclopentanyl acrylate, manufactured by Hitachi Chemical Co., Ltd.

IBXA: Isobornyl acrylate, manufactured by Osaka Organic Chemical Industry Ltd.

ACMO: Acryloyl morpholine, manufactured by KJ Chemicals Corporation

LIGHT ACRYLATE 130 A: Methoxypolyethylene glycol acrylate, manufactured by Kyoei Chemical Co., Ltd.

### <Tackifying Resin>

PINECRYSTAL KR-140: Ultra-light polymerized rosin, manufactured by Arakawa Chemical Industries Ltd.

PINECRYSTAL KE-100: Ultra-light rosin ester, manufactured by Arakawa Chemical Industries Ltd.

PINECRYSTAL KE-615-3: Rosin-containing diol, manufactured by Arakawa Chemical Industries, Ltd.

YS Polystar TH 130: Terpene phenolic resin, manufactured by Yasuhara Chemical Co., Ltd.

### <Antioxidant>

IRGANOX 1010: Hindered phenol-based antioxidant, manufactured by BASF Japan.

Sumilizer GA-80: Hindered phenol-based antioxidant, manufactured by Sumitomo Chemical Co., Ltd.

IRGANOX PS 800: Sulfur-based secondary antioxidant, manufactured by BASF Japan.

### <Radical Photoinitiator>

DAROCUR 1173: 2-Hydroxy-2-methyl-1-phenylpropan-1-one, manufactured by BASF Japan

IRGACURE 819: Bis(2,4,6-trimethylbenzoyl)-phenylphosphine oxide, manufactured by BASF Japan

IRGACURE 184: 1-Hydroxy-cyclohexyl-phenyl-ketone, manufactured by BASF Japan

IRGACURE 379: 2-(4-Methylbenzyl)-2-dimethylamino-1-(4-morpholin-4-yl-phenyl)-butan-1-one, manufactured by BASF Japan

### <Thermal Radical Initiator>

PERCUMYL D: Dicumyl peroxide, manufactured by NOF Corporation.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A radically curable composition comprising:
100 parts by weight of a (meth)acrylic polymer (I) with an average of at least 0.8 radically-crosslinkable groups;
0.01 to 10 parts by weight of a radical polymerization initiator (II); and
10 to 100 parts by weight of a (meth)acrylate compound (III) having a rosin ester group.

2. The radically curable composition according to claim 1, wherein the (meth)acrylic polymer (I) is a (meth)acrylic polymer having a radically-crosslinkable carbon-carbon double bond at a molecular terminal.

3. The radically curable composition according to claim 1, wherein the (meth)acrylic polymer (I) is a (meth)acrylic polymer having a (meth)acryloyl group at a molecular terminal.

4. The radically curable composition according to claim 1, wherein the (meth)acrylic polymer (I) has a molecular weight distribution of less than 1.8.

5. The radically curable composition according to claim 1, wherein the (meth)acrylic polymer (I) is obtained by polymerization or copolymerization of an acrylic acid alkyl ester monomer containing a saturated hydrocarbon group having 4 to 22 carbon atoms.

6. The radically curable composition according to claim 1, wherein the radical polymerization initiator (II) is a radical photoinitiator.

7. The radically curable composition according to claim 1, wherein the (meth)acrylate compound (III) is 1-acrylic acid-3-dehydroabietic acid-2-hydroxypropyl.

8. A cured product obtained from the radically curable composition according to claim 1.

9. A vibration damping material composed of the cured product according to claim 8.

10. A pressure-sensitive adhesive composed of the cured product according to claim 8.

11. An impact absorbing material composed of the cured product according to claim 8.
